(19) United States
(12) Patent Application Publication
(10) Pub. No.: US 2009/0245867 A1
(43) Pub. Date: Oct. 1, 2009

(54) ELECTROPHOTOGRAPHIC PHOTORECEPTOR, ELECTROPHOTOGRAPHIC PHOTORECEPTOR CARTRIDGE, AND IMAGE FORMING APPARATUS

(75) Inventors: Mitsuo Wada, Kanagawa (JP); Hiroaki Takamura, Kanagawa (JP); Teruyuki Mitsumori, Kanagawa (JP); Kazutaka Ida, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI CHEMICAL CORPORATION, MINATO-KU, TOKYO (JP)

(21) Appl. No.: 12/091,392

(22) PCT Filed: Oct. 26, 2006
(86) PCT No.: PCT/JP2006/321418

§ 371 Date: Dec. 3, 2008

(30) Foreign Application Priority Data
Oct. 26, 2005 (JP) 2005-311775

(51) Int. Cl. G03G 15/00; G03G 5/06

(52) U.S. Cl. 399/159; 430/78

(57) ABSTRACT

To provide an electrophotographic photoreceptor showing suitable electric characteristics, capable of forming a favorable image even after repeated use for long term and capable of forming a high quality image free from image defects such as a memory phenomenon, an electrophotographic process cartridge using such an electrophotographic photoreceptor, and an image forming apparatus using such an electrophotographic photoreceptor.

An electrophotographic photoreceptor comprising a photosensitive layer containing oxytitanium phthalocyanine showing chief diffraction peaks at Bragg angles (2θ±0.2°) of 9.6°, 24.1° and 27.2° to CuKα characteristic X-ray (wavelength: 1.541 Å) obtained by subjecting a phthalocyanine crystal precursor to chemical treatment and then bringing it into contact with an organic solvent, and a hydrazone compound represented by the following formula (1):

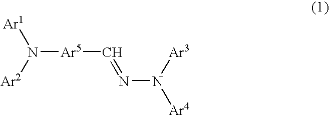

### TECHNICAL FIELD

The present invention relates to an electrophotographic photoreceptor using specific materials in combination, an electrophotographic photoreceptor cartridge and an image forming apparatus. Particularly, it relates to an electrophotographic photoreceptor to be used for laser printers, copying machines, facsimiles, etc., very useful to LED light and semiconductor laser light and excellent also in durability, an electrophotographic photoreceptor cartridge and an image forming apparatus.

### BACKGROUND ART

An electrophotographic technology has found widespread applications in a field of not only copying machines but also various printers and printing machines in recent years because it is excellent in immediacy and can provide an image of high quality.

As for the photoreceptor which is the core of the electrophotographic technology, photoreceptors using inorganic photoconductive materials such as selenium, an arsenic-selenium alloy or zinc oxide have been used. However, in recent years, photoreceptors using organic photoconductive materials having advantages of retaining no pollution, ensuring easy film-forming and production, having high degree of freedom of material selection and combination, and the like, have been mainly used.

As the layer structure of an organic photoreceptor, a so-called monolayer type photoreceptor having a charge generation substance (in the present specification, the “charge generation substance” will sometimes be referred to as a “charge generation material”) and a charge transport substance (in the present specification, the “charge transport substance” will sometimes be referred to as a “charge transfer material”) dispersed in a binder resin, and a lamination type photoreceptor having a charge generation layer and a charge transport layer have been known. The lamination type photoreceptor has been widely used because a stable high sensitivity photoreceptor can be provided by combining separate optimum layers of a charge generation substance and a charge transport substance each having a high efficiency, and characteristics are easily adjusted because of its wide material selection range.

Further, as a copying machine, a printer, a plain paper facsimile, etc. employing electrophotographic system, one which omits a charge removal step after a transfer step to simplify the process, to lower the cost, and the like, has been known. Namely, electrophotographic system including no step of charge removal by AC corona discharge, light or the like, as compared with a conventional electrophotographic system including a process of charging, exposure, development, transfer, cleaning, charge removal, etc.

However, in a case where a halftone image is printed after an image is printed by such a copying machine, printer, plain paper facsimile or the like which omits the charge removal step, a phenomenon such that a previously printed image appears at the halftone image portion, i.e. memory (ghost) phenomenon occurs in some cases. This memory phenomenon includes a positive memory phenomenon such that the image appears at a higher density and a negative memory phenomenon such that the density decreases.

Detailed mechanism of the memory phenomenon on an image has been unclear in many aspects and has not completely been understood yet, but one cause of the memory phenomenon is considered to be influences of charges injected to the photosensitive layer when opposite charge is applied in a transfer step in the electrophotographic process.

Further, in recent years, both copying machine and printer tend to form a full color image from a monochrome image. As a full color image forming method, mainly tandem method and four cycle method are employed, and as a system of transfer to a printing medium, direct transfer system, transfer drum system, intermediate transfer method, multiple development batch transfer system, etc. are employed. Among them, a color image forming apparatus which employs tandem system i.e. which forms images of respective colors by separate image forming units for the respective colors and sequentially transferring them, is an excellent image forming method since various types of recording materials can be used, a high full color quality is obtained, and a full color image can be obtained at high rate. Among them, its characteristic of forming a full color image at high rate is an advantageous not achieved by the other systems.

However, in the case of the tandem system, although high rate printing is possible, since images of the respective colors are formed by a plurality of image forming units and sequentially transferred, the thickness of the toner image transferred on a non-transfer medium (intermediate transfer medium or recording material) tends to be thick in the latter image forming unit, and it is necessary to apply a greater transfer voltage to transfer the toner layer formed on the electrophotographic photoreceptor. As a result, injection of charges to the photosensitive layer when the above reversed polarity is applied tends to be more remarkable, and the memory phenomenon occurs more apparently in some cases.

Along with speeding up of the electrophotographic process in recent years, high sensitivity and high responsibility as characteristics of the electrophotographic photoreceptor are essential. To achieve high sensitivity, optimization of the charge generation material and development of a charge transport material which well matches therewith are required, and to achieve high responsibility, development of a charge transport material having high mobility and a low residual potential is essential.

To achieve high sensitivity, a charge generation material having high charge generation capacity is required. Particularly, researches have been actively conducted on oxytitanium phthalocyanine showing high sensitivity to monochromatic exposure at from 600 to 850 nm which is dominantly used. Such oxytitanium phthalocyanine has been known to have crystal polymorphism. Particularly, a crystal form showing a chief diffraction peak at a Bragg angle (2θ±0.2°) of 27.2° to CuKα characteristic X-ray (wavelength: 1.541 Å) has been known to show a high quantum efficiency and show high sensitivity (e.g. Non-Patent Document 1).

This crystal form is produced mainly by crystal conversion from amorphous or low crystalline oxytitanium phthalocyanine. Such crystal forms are metastable crystal forms and have been known to show various crystal forms and particle shapes depending upon a difference in the production process, and have different characteristics as an electrophotographic photoreceptor such as charge generation capacity, triboelectricity and dark decay depending upon the production process. Further, the image quality to be obtained when a photoreceptor is prepared and it is mounted on an actual machine such as a copying machine, a printer or a plain paper facsimile varies, and it is difficult to estimate various performances from the production process.

Further, to achieve high responsibility, development of a charge transport material having high mobility and a sufficiently low residual potential at the time of exposure and well matching with the charge generation material is required. As an index of high mobility, indices of molecular design of the charge transport material such as making the dipole moment of molecules, the polarizability, etc. to be certain values or more (e.g. Patent Document 1) have become clear, and various charge transport materials having high mobility and a low residual potential have been developed. However, even if electrophotographic photoreceptor characteristics such as mobility and a low residual potential are satisfied, the image quality obtained by an actual copying machine or laser printer or influences of the peripheral process such as transfer vary in some cases by a difference in the basic molecular skeleton or the substitution position of a substituent of the charge transport material, and it has not been clear where these differences come from.

Patent Document 1: JP-A-10-312070

Non-Patent Document 1: DENSHI SHASHIN GAKKAISHI (Electrophotography), 1990, Vol. 29, No. 3, p. 250 to 258

### DISCLOSURE OF THE INVENTION

### Problems to be Solved by the Invention

An electrophotographic photoreceptor comprising a charge generation material known to show high sensitivity and a charge transport material having high mobility and a low residual potential in combination, can satisfy basic characteristics (e.g. sensitivity, residual potential, triboelectricity and dark decay) as an electrophotographic photoreceptor. However, if an electrophotographic photoreceptor having a high sensitivity charge generation material and a charge transport material having high mobility and a low residual potential merely combined is mounted on the above-described tandem full color image forming apparatus or an image forming apparatus such as a printer, a copying machine or a plain paper facsimile, employing an electrophotographic process comprising at least charging, exposure, development and transfer steps, characterized by not including a charge removal step after the transfer step, image defects such as a memory phenomenon are more remarkable in some cases.

### Means to Solve the Problems

The present inventors have conducted extensive studies to solve the above problems and as a result, found that an electrophotographic photoreceptor capable of forming a high quality image free from image defects such as a memory phenomenon can be obtained by combining oxytitanium phthalocyanine containing a chlorinated product in a specific amount obtained by a specific process for producing a charge generation material and a charge transport material having a specific structure, and accomplished the present invention.

Namely, the present invention provides the following.

(1) An electrophotographic photoreceptor comprising an electroconductive substrate and a photosensitive layer formed thereon, characterized in that the photosensitive layer contains oxytitanium phthalocyanine showing chief diffraction peaks at Bragg angles (2θ±0.2°) of 9.6°, 24.1° and 27.2° to CuKα characteristic X-ray (wavelength: 1.541 Å) obtained by subjecting a phthalocyanine crystal precursor to chemical treatment and then bringing it into contact with an organic solvent, and a hydrazone compound having a specific structure.

Namely, oxytitanium phthalocyanine is obtained by subjecting a phthalocyanine crystal precursor to chemical treatment and then bringing it into contact with an organic solvent, and shows chief diffraction peaks at Bragg angles (2θ±0.2°) of 9.6°, 24.1° and 27.2° to CuKα characteristic X-ray (wavelength: 1.541 Å). More specifically, a phthalocyanine crystal precursor is subjected to chemical treatment and then brought into contact with an organic solvent to obtain oxytitanium phthalocyanine in a specific crystal form.

(2) An electrophotographic photoreceptor comprising an electroconductive substrate and a photosensitive layer formed thereon, characterized in that the photosensitive layer contains oxytitanium phthalocyanine showing chief diffraction peaks at Bragg angles (2θ±0.2°) of 9.5°, 9.7°, 24.2° and 27.2° to CuKα characteristic X-ray (wavelength: 1.541 Å) obtained by subjecting a phthalocyanine crystal precursor to chemical treatment and then bringing it into contact with an organic solvent, and a hydrazone compound having a specific structure.

Namely, the oxytitanium phthalocyanine is obtained by subjecting a phthalocyanine crystal precursor to chemical treatment and then bringing it into contact with an organic solvent, and shows chief diffraction peaks at Bragg angles (2θ±0.2°) of 9.5°, 9.7°, 24.2° and 27.2° to CuKα characteristic X-ray (wavelength: 1.541 Å). More specifically, a phthalocyanine crystal precursor is subjected to chemical treatment and then brought into contact with an organic solvent to obtain oxytitanium phthalocyanine in a specific crystal form.

(3) An electrophotographic photoreceptor comprising an electroconductive substrate and a photosensitive layer formed thereon, characterized in that the photosensitive layer contains oxytitanium phthalocyanine showing a chief diffraction peak at a Bragg angle (2θ±0.2°) of 27.2° to CuKα characteristic X-ray (wavelength: 1.541 Å) obtained by crystal conversion from oxytitanium phthalocyanine having a chlorine content of at most 0.4 wt %, or oxytitanium phthalocyanine in which the ratio of chlorinated oxytitanium phthalocyanine to non-substituted oxytitanium phthalocyanine is at most 0.05 by the mass spectrum intensity ratio, and a hydrazone compound having a specific structure.

Namely, the oxytitanium phthalocyanine is obtained by crystal conversion of oxytitanium phthalocyanine having a predetermined fluorine content or a predetermined mass spectrum intensity ratio. More specifically, oxytitanium phthalocyanine having a predetermined chlorine content or a predetermined mass spectrum intensity ratio is subjected to crystal conversion to obtain oxytitanium phthalocyanine in a specific crystal form.

(4) An electrophotographic process cartridge, comprising the electrophotographic photoreceptor as defined in any one of the above (1) to (3), constituted to be removable from an image forming apparatus.

(5) An image forming apparatus, comprising the electrophotographic photoreceptor as defined in any one of the above (1) to (3), and at least one of a charging portion to charge the electrophotographic photoreceptor, an exposure portion to expose the charged electrophotographic photoreceptor to form an electrostatic latent image, and a developing portion to develop the electrostatic latent image formed on the electrophotographic photoreceptor.

(6) The image forming apparatus according to the above (5), which comprises no charge removal process.

### EFFECTS OF THE INVENTION

By the electrophotographic photoreceptor (1) of the present invention using oxytitanium phthalocyanine is showing chief diffraction peaks at Bragg angles (2θ±0.2°) of 9.6°, 24.1° and 27.2° to CuKα characteristic X-ray (wavelength: 1.541 Å) obtained by subjecting a phthalocyanine precursor to chemical treatment and then bringing it into contact with an organic solvent, and a hydrazone compound having a specific structure as the charge transport materials, the electrophotographic photoreceptor (2) of the present invention using oxytitanium phthalocyanine showing chief diffraction peaks at Bragg angles (2θ±0.2°) of 9.5°, 9.7°, 24.2° and 27.2° to CuKα characteristic X-ray (wavelength: 1.541 Å) obtained by subjecting a phthalocyanine precursor to chemical treatment and then bringing it into contact with an organic solvent, and a hydrazone compound having a specific structure as the charge transport materials, the electrophotographic photoreceptor (3) of the present invention using oxytitanium phthalocyanine showing a chief diffraction peak at a Bragg angle (2θ+0.2°) of 27.2° to CuKα characteristic X-ray (wavelength: 1.541 Å) obtained by crystal conversion from oxytitanium phthalocyanine having a chlorine content of at most 0.4 wt %, or oxytitanium phthalocyanine in which the ratio of chlorinated oxytitanium phthalocyanine to non-substituted oxytitanium phthalocyanine is at most 0.05 by the mass spectrum intensity ratio, and a hydrazone compound having a specific structure as the charge transport materials, etc., an electrophotographic photoreceptor capable of is forming a high quality image free from image defects such as a memory phenomenon, an electrophotographic process cartridge comprising the electrophotographic photoreceptor, and an image forming apparatus comprising the electrophotographic photoreceptor, can be provided.

### BRIEF DESCRIPTION OF THE DRAWINGS

FIG. 1 is a drawing schematically illustrating a structure of a substantial part of one embodiment of the image forming apparatus of the present invention.

FIG. 2 is an X-ray diffraction spectrum of β-form oxytitanium phthalocyanine obtained in Preparation Example 1.

FIG. 3 is an X-ray diffraction spectrum of low crystalline oxytitanium phthalocyanine obtained in Preparation Example 3.

FIG. 4 is an X-ray diffraction spectrum of oxytitanium phthalocyanine obtained in Preparation Example 3.

FIG. 5 is an X-ray diffraction spectrum of oxytitanium phthalocyanine obtained in Preparation Example 4.

FIG. 6 is an X-ray diffraction spectrum of low crystalline oxytitanium phthalocyanine obtained in Preparation Example 5.

FIG. 7 is an X-ray diffraction spectrum of oxytitanium phthalocyanine obtained in Preparation Example 5.

FIG. 8 is an X-ray diffraction spectrum of oxytitanium phthalocyanine before crystal conversion obtained in Comparative Preparation Example 1.

FIG. 9 is an X-ray diffraction spectrum of oxytitanium phthalocyanine obtained in Comparative Preparation Example 1.

### MEANINGS OF SYMBOLS

1: Photoreceptor (electrophotographic photoreceptor)
2: Charging apparatus (charging roller, charging portion)
3: Exposure apparatus (exposure portion)
4: Developing apparatus (developing portion)
5: Transfer apparatus
6: Cleaning apparatus (cleaning portion)
7: Fixing apparatus
41: Developing tank
42: Agitator
43: Supply roller
44: Developing roller
45: Control member
71: Upper fixing member (pressure roller)
72: Lower fixing member (fixing roller)
73: Heating apparatus
T: Toner
P: Recording paper (paper sheet, medium)

### BEST MODE FOR CARRYING OUT THE INVENTION

Now, the present invention will be described in further detail with reference to the preferred embodiments. However, the present invention is by no means restricted to the following description, and various changes and modifications can be made without departing from the spirit and scope of the present invention.

In the present invention, a high performance electrophotographic photoreceptor is obtained by use of oxytitanium phthalocyanine in a specific crystal form obtained by subjecting a phthalocyanine precursor to chemical treatment and bringing it into contact with an organic solvent, and a specific hydrazone compound in combination.

Further, in the present invention, a high performance electrophotographic photoreceptor is obtained by use of oxytitanium phthalocyanine in a specific crystal form obtained by crystal conversion of oxytitanium phthalocyanine having a predetermined chlorine content or a predetermined mass spectrum intensity ratio, and a specific hydrazone compound in combination. Whether or not oxytitanium phthalocyanine having such specific physical property values is obtained before the crystal conversion is confirmed by the after-mentioned method of measuring the chlorine content and method of measuring the mass spectrum intensity ratio. Further, the crystal conversion method is not particularly limited, and preferably a method comprising chemical treatment and contact into an organic solvent is employed.

(Oxytitanium Phthalocyanine Obtained by Chemical Treatment and Contact with Organic Solvent)

The photosensitive layer of the electrophotographic photoreceptor of the present invention contains specific oxytitanium phthalocyanine, which is obtained by subjecting a phthalocyanine precursor to chemical treatment and bringing it into contact with an organic solvent.

In the present invention, the chemical treatment is treatment employed at a stage of preparing amorphous oxytitanium phthalocyanine or low crystalline oxytitanium phthalocyanine.

The chemical treatment is not a method to obtain amorphous oxytitanium phthalocyanine or low crystalline oxytitanium phthalocyanine merely by physical force (such as mechanical grinding) but a treatment method to obtain amorphous or low crystalline oxytitanium phthalocyanine by employing a chemical phenomenon such as dissolution or reaction.

Specifically, the chemical treatment may, for example, be an acid pasting method in which the phthalocyanine precursor is dissolved in a strong acid (in the present specification, the “acid pasting method” will sometimes be referred to simply as an “acid paste method”), an acid slurry method via a dispersed state in a strong acid, or a method of adding phenol or an alcohol to dichlorotitanyl phthalocyanine, followed by desorption to obtain oxytitanium phthalocyanine. In order to obtain more stable amorphous or low crystalline oxytitanium phthalocyanine, the acid paste method or the acid slurry method is preferred, and the acid paste method is more preferred.

The acid paste method or the acid slurry method is a method in which a pigment is dissolved, or suspended or dispersed in a strong acid to prepare a solution, and the prepared solution is poured in a medium which is uniformly miscible with a strong acid and in which substantially no pigment is dissolved (in the case of oxytitanium phthalocyanine, e.g. water, an alcohol such as methanol, ethanol, propanol or ethylene glycol, an ether such as ethylene glycol monomethyl ether, ethylene glycol diethyl ether or tetrahydrofuran) to form the pigment again thereby to modify the pigment.

In the acid slurry method or the acid paste method, a strong acid such as concentrated sulfuric acid, organic sulfonic acid, organic phosphonic acid or trihalogenated acetic acid is used. Such strong acids may be used alone, as a mixture of the strong acids, or in combination of the strong acid with an organic solvent. The strong acid is preferably trihalogenated acetic acid or concentrated sulfuric acid considering the solubility of the phthalocyanine precursor, and more preferably concentrated sulfuric acid considering the production cost.

The concentration of the sulfuric acid is preferably at least 90 wt % considering the solubility of the phthalocyanine precursor, and more preferably at least 95 wt %, since the production efficiency will decrease if the sulfuric acid content is low.

The temperature at which the phthalocyanine precursor is dissolved in the strong acid may be the temperature disclosed in known literature. It is preferably at most 5° C. since the phthalocyanine ring of the precursor will be opened, thus leading to decomposition if the temperature is too high, and it is more preferably at most 0° C. considering the influence over the electrophotographic photoreceptor to be obtained.

The strong acid may be used in an optional amount, and the amount of the strong acid is at least 5 parts by weight per 1 part by weight of the phthalocyanine precursor since the solubility of the phthalocyanine precursor tends to be poor if it is too small, preferably at least 15 parts by weight since the stirring efficiency will decrease if the solid content concentration in the solution is too high, more preferably at least 20 parts by weight. Further, it is preferably at most 100 parts by weight since the amount of disposal of the acid will increase if the amount of use of the strong acid is too large, and more preferably at most 50 parts by weight considering the production efficiency.

The medium in which the obtained acid solution of the phthalocyanine precursor is poured may, for example, be water, an alcohol such as methanol, ethanol, 1-propanol or 2-propanol; a polyhydric alcohol such as ethylene glycol or glycerol: a cyclic ether such as tetrahydrofuran, dioxane, dioxolane or tetrahydropyran; or a cyclic ether such as ethylene glycol monomethyl ether or ethylene glycol diethyl ether. In the same manner as the known method, the mediums may be used alone or as a mixture of two or more. The particle shape, the crystal state, etc. of the pigment formed again vary depending upon the medium to be used, and this history may effect characteristics of an electrophotographic photoreceptor comprising the final crystals to be obtained, and accordingly preferred is water or a lower alcohol such as methanol, ethanol, 1-propanol or 2-propanol, and more preferred is water in view of productivity and the cost.

The oxytitanium phthalocyanine obtained by pouring the concentrated sulfuric acid solution of the phthalocyanine precursor in the medium to form the pigment again, is collected by filtration as a wet cake. As the wet cake contains a large amount of impurities such as sulfate ions of the concentrated sulfuric acid present in the medium, it is washed with a washing medium after formation into the pigment again. The medium for washing may, for example, be an alkaline aqueous solution such as a sodium hydroxide aqueous solution, a potassium hydroxide aqueous solution, a sodium hydrogen carbonate aqueous solution, a sodium carbonate aqueous solution, a potassium carbonate aqueous solution, a sodium acetate aqueous solution or an ammonia aqueous solution, an acidic aqueous solution such as diluted hydrochloric acid, diluted nitric acid or diluted acetic acid, or water such as deionized water. As ionic substances remaining in the pigment adversely affect characteristics of the electrophotographic photoreceptor in many cases, preferred is water from which ionic substances are removed, such as deionized water.

Usually, the oxytitanium phthalocyanine to be obtained by the acid paste method or the acid slurry method is amorphous one showing no clear diffraction peak or low crystalline one showing a peak of which the intensity is very weak and which has a very broad half value width.

Usually, by bringing the amorphous oxytitanium phthalocyanine or the low crystalline oxytitanium phthalocyanine obtained by the acid paste method or the acid slurry method into contact with an organic solvent, oxytitanium phthalocyanine showing chief diffraction peaks at Bragg angles (2θ±0.2°) of 9.6°, 24.1° and 27.2° or 9.5°, 9.7°, 24.2° and 27.20 to CuKα characteristic X-ray (wavelength: 1.541 Å) to be used for the electrophotographic photoreceptor of the present invention can be obtained. Peaks at Bragg angles (2θ+0.2°) to CuKα characteristic X-ray (wavelength: 1.541 Å) of the oxytitanium phthalocyanine crystals of the present invention can be measured by any known method.

The specific oxytitanium phthalocyanine of the present invention is obtained by chemical treatment and contact with an organic solvent. The amorphous oxytitanium phthalocyanine and the low crystalline oxytitanium phthalocyanine after chemical treatment will be abbreviated as a “low crystalline phthalocyanine”).

In the present invention, the “low crystalline phthalocyanine” is a phthalocyanine showing no peak having a half value width of at most 0.30° within a range of Bragg angles (2θ±0.2°) of from 0 to 40° to CuKα characteristic X-ray (wavelength: 1.541 Å) in powder X-ray diffraction (hereinafter sometimes abbreviated as “XRD”) spectrum. If the half value width is too narrow, phthalocyanine molecules are in a state of having certain regularity and long-term order to a certain extent in the solid, whereby when oxytitanium phthalocyanine of the present invention is to be obtained by contact with an organic solvent, controllability of the crystal form may decrease in some cases. Accordingly, the low crystalline phthalocyanine used in the present invention is preferably one showing no peak having a half value width of usually at most 0.35°, particularly at most 0.40°, especially at most 0.45°.

In the present specification, measurement of the powder X-ray diffraction spectrum of the phthalocyanine, determination of Bragg angles (2θ±0.2°) to CuKα characteristic X-ray (wavelength: 1.541 Å) and calculation of the peak half value width are conducted under the following conditions.

As apparatus for measuring the powder X-ray diffraction spectrum, a focusing optics type powder X-ray diffractometer employing CuKα (CuKα1+CuKα2) rays as an X-ray source (e.g. PW1700 manufactured by PANanalytical) is used. The conditions of measurement of the powder X-ray diffraction spectrum are such that scanning range (2θ): 3.0 to 40.0°, scan step width: 0.05°, scanning rate: 3.0°/min, divergence slit: 1°, scattering slit: 1°, receiving slit: 0.2 mm.

The peak half value width can be calculated by a profile fitting method. The profile fitting may be conducted by using powder X-ray diffraction pattern analytical software JADE5.0+ manufactured by MDI. The calculation conditions are as follows.

First, the background is fixed at an ideal position within the entire measurement range (2θ=3.0 to 40.0°). As the fitting function, Peason-VII function considering contribution of CuKα2 is employed. As the variables of the fitting function, three of the diffraction angle (2θ), the peak height and the peak half value width (β₀) are refined. The influence of the CuKα2 is removed, and the diffraction angle (2θ), the peak height and the peak half value width (β₀) attributable to CuKα1 are calculated. The asymmetry is fixed to 0, and the constant is fixed to 1.5.

The peak half value width (β₀) calculated by the above profile fitting method is calibrated in accordance with the following formula from the peak half value width (βSi) of 111 peak (2θ=28.442°) of standard Si (NIST Si 640b) calculated under the same profile fitting conditions under the same measurement conditions to determine the peak half value width (β) of the sample:

$$β = \sqrt{{β}_{o}^{2} - {β}_{Si}^{2}}$$

The boundary between the amorphous oxytitanium phthalocyanine and the low crystalline oxytitanium phthalocyanine is not clear, and in the present invention, it is possible to obtain specific oxytitanium phthalocyanine of the present invention by using either of them as the material.

As described hereinafter, crystals of the oxytitanium phthalocyanine of the present invention show chief diffraction peaks at Bragg angles (2θ±0.2°) of 9.6°, 24.1° and 27.2° or 9.5°, 9.7°, 24.2° and 27.2° to is CuKα characteristic X-ray (wavelength: 1.541 Å). A low crystalline phthalocyanine showing a peak in the vicinity of 27.2° has regularity similar to a certain extent to the above oxytitanium phthalocyanine in a specific crystal form, and is excellent in crystal form controllability over the specific crystal form. In such a case, the low crystalline phthalocyanine is one showing no peak having a half value width of usually at most 0.30°, preferably at most 0.35°, more preferably at most 0.40°, furthermore preferably at most 0.45°.

On the other hand, when a low crystalline phthalocyanine showing no peak in the vicinity of 27.2° is used as the material of the oxytitanium phthalocyanine of the present invention, it preferably has lower crystallinity, since it has low crystal form controllability over the above oxytitanium phthalocyanine in a specific crystal form. In such a case, the low crystalline phthalocyanine is one showing no peak having a half value width of usually at most 0.30°, preferably at most 0.50°, more preferably at most 0.70°, furthermore preferably at most 0.90°.

Usually, contact between the low crystalline phthalocyanine and the organic solvent is carried out in the presence of water. As the water, water contained in the wet cake obtained by the acid paste method or the acid slurry method may be used, or water may further be added in addition to water contained in the wet cake. Further, the wet cake obtained after the acid paste method or the acid slurry method may be once dried, and then water is newly added at the time of crystal conversion. However, if it is dried, affinity between the pigment and water tends to decrease, and accordingly it is preferred to use water contained in the wet cake obtained by the acid paste method or the acid slurry method without drying or to further add water to the water contained in the wet cake.

The solvent to be used for crystal conversion may be either a solvent compatible with water or a solvent incompatible with water. Preferred examples of the solvent compatible with water include cyclic ethers such as tetrahydrofuran, 1,4-dioxane and 1,3-dioxolane. Further, preferred examples of the solvent incompatible with water include aromatic hydrocarbon solvents such as toluene, naphthalene and methylnaphthalene; halogenated hydrocarbon solvents such as monochlorobenzene, dichlorobenzene, chlorotoluene, dichlorotoluene, dichlorofluorobenzene and 1,2-dichloroethane, and substituted aromatic solvents such as nitrobenzene, 1,2-methylenedioxybenzene and acetophenone. Among them, a cyclic ether, a halogenated hydrocarbon such as monochlorobenzene, 1,2-dichlorobenzene, dichlorofluorobenzene or dichlorotoluene, or an aromatic hydrocarbon solvent is preferred, whereby electrophotographic characteristics of crystals to be obtained are favorable. Particularly, tetrahydrofuran, monochlorobenzene, 1,2-dichlorobenzene, 2,4-dichlorotoluene, dichlorofluorobenzene, toluene or naphthalene is more preferred in view of stability at the time of dispersion of the obtained crystals.

The crystals obtained after crystal conversion are subjected to a drying step. The drying method may, for example, be a known method such as air drying, drying by heating, vacuum drying or freeze drying.

The oxytitanium phthalocyanine crystals obtained by the above production process are crystals showing chief diffraction peaks at Bragg angles (2θ±0.2°) of 9.6°, 24.1° and 27.2° or 9.5°, 9.7°, 24.2° and 27.2° to CuKα characteristic X-ray (wavelength: 1.541 Å). Crystals showing a diffraction peak in the vicinity of 26.2° are poor in crystal stability at the time of dispersion and accordingly preferred are crystals showing no peak in the vicinity of 26.2°. Particularly, crystals showing chief diffraction peaks at 7.3°, 9.6°, 11.6°, 14.2°, 18.0°, 24.1° and 27.2°, or 7.3°, 9.5°, 9.7°, 11.6°, 14.2°, 18.0°, 24.2° and 27.2°, are preferred from the viewpoint of the dark decay and the residual potential when used as the electrophotographic photoreceptor. The Bragg angle has an error of ±0.2° as shown by 2θ±0.2°. Therefore, for example, a “Bragg angle (2θ+0.2°) of 9.60” means a range of from 9.4° to 9.8°. This range of the error similarly applies to other angles.

The particle size of the oxytitanium phthalocyanine greatly varies depending upon the production process and the crystal conversion method. However, considering dispersibility, when the average of maximum sizes of optional ten particles observed in a SEM photograph is regarded as the average primary particle size, the average primary particle size is preferably at most 500 nm, and in view of coating and film formation properties, it is preferably at most 250 nm.

The chlorine content in the oxytitanium phthalocyanine crystals of the present invention can be measured by any known method. More specifically, it may be measured by the method disclosed in the following “measurement of chlorine content”. Further, the mass spectrum intensity ratio of chlorinated oxytitanium phthalocyanine to non-substituted oxytitanium phthalocyanine can be measured by any known method. Specifically, the mass spectrum intensity ratio of chlorinated oxytitanium phthalocyanine to non-substituted oxytitanium phthalocyanine may be determined under conditions disclosed in “measurement of mass spectrum”.

### (Measurement of Chlorine Content)

About 100 mg of oxytitanium phthalocyanine was accurately weighed, put on a quartz board and completely burned by a temperature-raising electronic furnace QF-02 manufactured by Mitsubishi Chemical Corporation, and the combustion gas was quantitatively absorbed in 15 mL of water. The water was diluted to 50 mL and subjected to Cl analysis by ion chromatography (DX-120 manufactured by Dionex). The conditions of the ion chromatography are shown below.

Column: Dionex Ion Pak AG12A+AS12A

Eluent: A mixed liquid of 2.7 mM Na₂CO₃/0.3 mM NaHCO₃

Flow rate: 1.3 mL/min

Amount of injection: 50 μL

### (Measurement of Mass Spectrum)

### 1. Preparation of Sample

0.50 g of oxytitanium phthalocyanine together with 30 g of glass beads (diameter: 1.0 to 1.4 mm) and 10 g of cyclohexanone was put in a 50 mL glass container, followed by dispersion treatment by a dye dispersion testing machine (paint shaker) for 3 hours to prepare an oxytitanium phthalocyanine dispersion liquid. 1 μL of the dispersion liquid was sampled in a 20 mL sample tube, and 5 mL of chloroform was added, followed by ultrasonic dispersion for one hour to prepare a 10 ppm dispersion liquid.

### 2. Measurement Apparatus and Conditions

Measurement apparatus: JMS-700/M Station manufactured by JEOL Ltd.

Ionization mode: DCI (−)

Reaction gas: Isobutane (ionization chamber pressure: 1×10⁻⁵ Torr)

Filament rate: 0→0.90A (1A/min)

Mass spectrometry performance (m/z): 2000

Scanning method: MF-linear

Scanning mass range: 500 to 600

Total mass range scanning time: 0.8 sec

Cycling time: 0.5 sec

### 3. Method of Calculating the Mass Spectrum Intensity Ratio of Chlorinated Oxytitanium Phthalocyanine to Non-Substituted Oxytitanium Phthalocyanine

1 μL of the dispersion liquid for measurement was applied to a filament of a DCI probe, and the mass spectrum was measured under the above conditions. In the obtained mass spectrum, the ratio of the peak area obtained from the ion chromatography of m/z=610 corresponding to molecular ions of chlorinated oxytitanium phthalocyanine to m/z=576 corresponding to molecular ions of non-substituted oxytitanium phthalocyanine (“610” peak area/“576” peak area) is calculated as the mass spectrum intensity ratio.

The type of chlorine content contained in the oxytitanium phthalocyanine may, for example, be a residue of the solvent used for the reaction, an ion species derived from titanium tetrachloride used as the material, or chlorinated oxytitanium phthalocyanine contained in the crystals formed by chlorination of a phthalocyanine ring in the reaction system when titanium tetrachloride is used as a central metal source. Among these impurities, most of the impurities from the reaction solvent and the ion species can be washed away by a washing operation after the reaction. Whereas, the chlorinated oxytitanium phthalocyanine can not easily be removed since when phthalocyanine crystals are formed in the reaction system, it is incorporated in the crystals, whereby it remains until the final stage and remains as the chlorine content. It has not been clearly understood how the remaining chlorinated oxytitanium phthalocyanine influences the memory phenomenon on an image. However, it is estimated that by incorporation of the chlorinated oxytitanium phthalocyanine, the crystal lattice is distorted, or the surface charge state of the crystal particles are influenced, and these influences relate to trapping of charges near the interface at which the charge transport material and the charge generation material are in contact.

The chlorine content measured based on the above-described elemental analysis means is preferably at most 04 wt %. The reason is not clearly understood, but oxytitanium phthalocyanine crystals showing chief diffraction peaks at a Bragg angle (2θ±0.2°) of 27.2° to CuKα characteristic X-ray (wavelength: 1.541 Å) as impurities are in a metastable crystal form, are weak against external impact such as physical force and tend to undergo dislocation to a stable crystal form. If a large molecule group such as a compound having a chlorine atom is present in the crystals, distortion of molecular arrangement in the crystals tends to be significant, whereby the crystals tend to be susceptible to physical force, and the crystal stability tends to decrease. Therefore, the chlorine content is preferably at most 0.3 wt %. Further, if e.g. a compound having a chlorine atom is present, the intermolecular distance in the crystals tends to be long, the interaction of the π-electron system between the molecular aspects tends to decrease, and the charge generation performance will be impaired. Accordingly, the chlorine content is more preferably at most 0.2 wt %.

The amount of the chlorinated oxytitanium phthalocyanine formed by chlorination of the phthalocyanine ring can be determined based on the above-described sample preparation method, the measurement method and the method for calculating the mass spectrum intensity ratio of the mass spectrum. As described above, if the chlorinated oxytitanium phthalocyanine is contained in the crystals, the volume of a single molecule tends to be large corresponding to substitution by the chlorine group, whereby the molecular arrangement in the crystals is influenced, and the stability of the crystals tends to decrease. Accordingly, the mass spectrum intensity ratio is preferably at most 0.05, more preferably at most 0.04, and since the sensitivity tends to deteriorate if the content of the chlorinated oxytitanium phthalocyanine is high, it is more preferably at most 0.03.

### (Hydrazone Compound)

For the electrophotographic photoreceptor of the present invention, a hydrazone compound having a specific structure is used. The mechanism how the hydrazone compound having the after-mentioned structure relates to the memory development is not clear, but it is estimated that by having a specific basic skeleton and having a substituent at the specific position, the interaction with the charge generation material will be relaxed, and the hydrazone compound is in contact with the charge generation material in a state where charges injected when contacted with the charge generation material are hardly trapped.

For the electrophotographic photoreceptor of the present invention, a hydrazone compound having the structure of the following formula (I) is used:

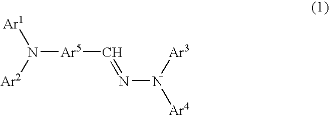

wherein each of Ar¹ and Ar² is an aryl group, provided that at least one of Ar¹ and Ar² is an aryl group having a substituent, each of Ar³ and Ar⁴ is a phenyl group which may have a substituent, and Ar⁵ is an arylene group which may have a substituent. Ar¹ and Ar² may form an alicyclic structure such as a cyclopentyl group or a cyclohexyl group by bonding of the substituents. However, if Ar¹ and Ar², or Ar³ and Ar⁴, are directly bonded or bonded via an alkylene group or the like to form a cyclic structure, characteristics of the electrophotographic photoreceptor may be impaired, such as deterioration of the sensitivity and the increase in the residual potential. Therefore, Ar¹ and Ar², or Ar³ and Ar⁴, do not form a cyclic structure by direct bond or via an alkylene group or the like.

The aryl group represented by each of Ar¹ and Ar² may, for example, be a phenyl group, a naphthyl group, a phenanthryl group or an anthryl group. If the conjugated system highly expands by substitution of e.g. a condensed polycyclic ring, the interaction among molecules tends to be intense, whereby solubility in a solvent tends to decrease, and accordingly preferred is a phenyl group.

The substituent which each of Ar¹, Ar², Ar³ and Ar⁴ may have, may, for example, be a lower alkyl group having at most 5 carbon atoms such as a methyl group, a methoxy group, an ethoxy group or a 2-propyl group, or an alkoxy group having at most 5 carbon atoms such as a methoxy group or an ethoxy group. In a case where Ar¹, Ar², Ar³ or Ar⁴ has a substituent, considering the durability against repeated use when used for the electrophotographic photoreceptor, and durability against ozone, preferred is an alkyl group having at most 3 carbon atoms. Among them, from the viewpoint of mobility as the charge transport material, it is more preferred that both Ar¹ and Ar² are 4-methylphenyl groups. Further, considering the residual potential when used for the electrophotographic photoreceptor, it is more preferred that Ar³ and Ar⁴ are phenyl groups having no substituent.

Ar⁵ is an arylene group which may have a substituent. The arylene group may, for example, be a phenylene group, a naphthylene group or an anthrylene group. The substituent which it may have may, for example, be a lower alkyl group having at most 5 carbon atoms such as a methyl group, an ethyl group, a propyl group or an isopropyl group, or an alkoxy group having at most 5 carbon atoms such as a methoxy group or an ethoxy group. If Ar⁵ has a condensed polycyclic structure, solubility in an organic solvent to be used when the photoreceptor layer is formed by coating tends to decrease, and accordingly preferred is a phenylene group. When Ar⁵ has a substituent, considering durability against repeated use when used for the electrophotographic photoreceptor and durability against ozone, preferred is an alkyl group having at most 3 carbon atoms. However, if Ar⁵ has a substituent, twisting may occur in the molecules, thus decreasing the mobility, and accordingly Ar⁵ is preferably a 1,4-phenylene group having no substituent.

Suitable structures of the hydrazone compounds to be used in the present invention are exemplified below. However, these examples are shown to define the scope of the present invention, and the present invention is not limited to the exemplified structures without departing from the spirit and scope of the present invention:

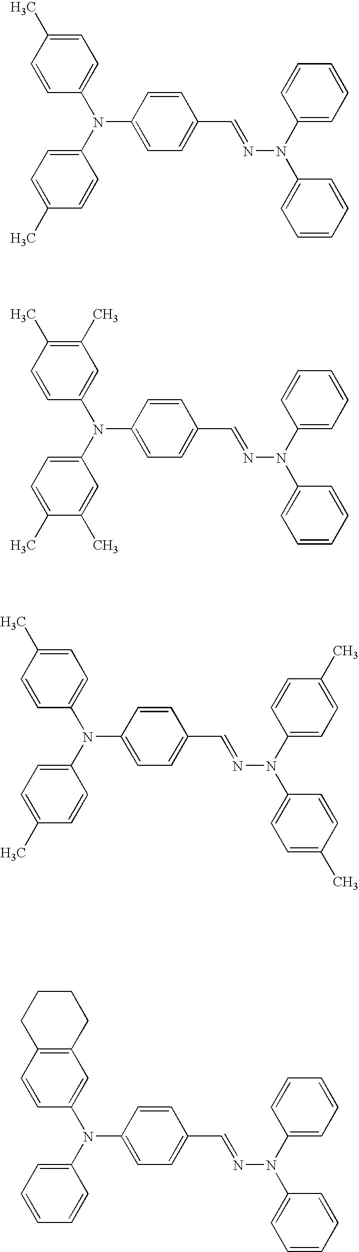

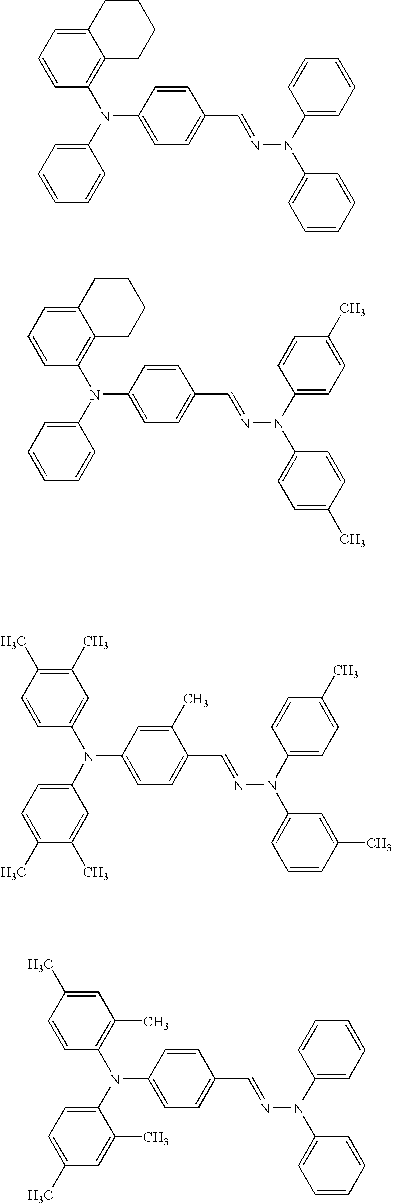

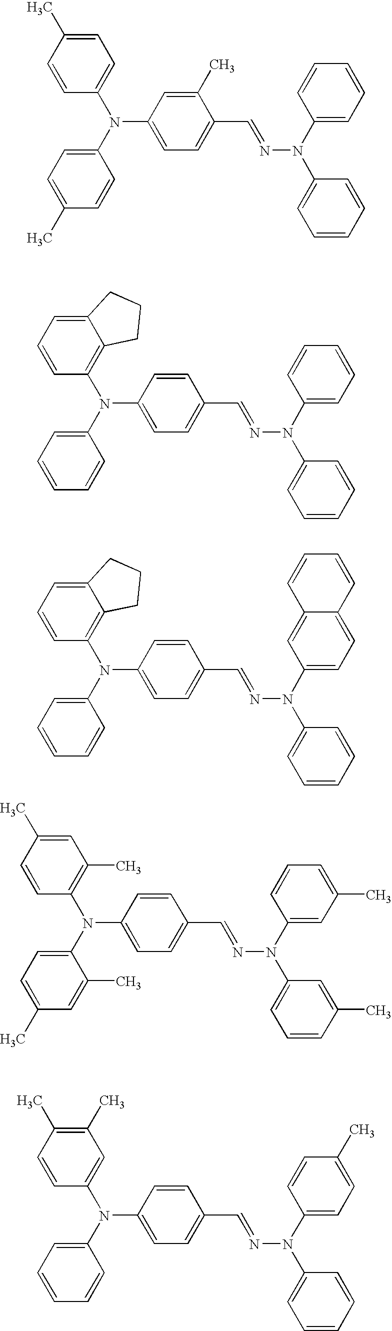

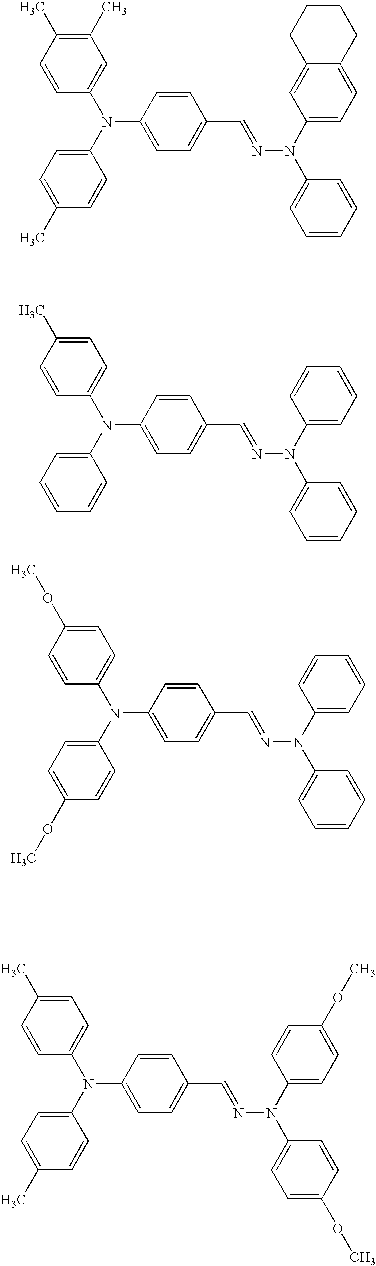

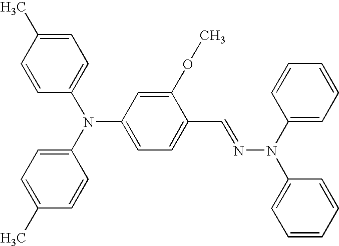

### (Electrophotographic Photoreceptor)

Now, the electrophotographic photoreceptor of the present invention will be described.

The photosensitive layer formed on the electroconductive substrate may be one having a monolayer structure in which the charge generation substance and the charge transport substance are present in the same layer and dispersed in a binder resin. Further, the photosensitive layer formed on the electroconductive substrate may be one having a laminated structure in which the functions are separated into a charge generation layer having the charge generation substance dispersed in a binder and a charge transport layer having the charge transport substance dispersed in a binder resin (the photoreceptor having a laminated structure of which the functions are separated will sometimes be referred to as a “function-separated photoreceptor”). When the photosensitive layer has a laminated structure, the charge generation layer comprises a charge generation substance including the above oxytitanium phthalocyanine as at least one type of the charge generation substance, and a binding resin.

The charge generation layer in the function-separated photoreceptor is formed by dispersing a charge generation substance including at least one type of the above oxytitanium phthalocyanine in a solution having the binding resin dissolved in an organic solvent to prepare a coating liquid, and applying it to an electroconductive substrate so that fine particles of the charge generation substance and the binder resin are bound.

As the charge generation substance, oxytitanium phthalocyanine may be used alone or it may be used as mixed with a dye or a pigment.

The dye or the pigment to be used as mixed with the oxytitanium phthalocyanine may, for example, be a phthalocyanine pigment, an azo pigment, a dithioketopyrrolopyrole pigment, a squarene (squarylium) pigment, a quinacridone pigment, an indigo pigment, a perylene pigment, a polycyclic quinone pigment, an anthanthrone pigment or a benzoimidazole pigment.

The dye or the pigment to be used as mixed is preferably a phthalocyanine pigment or an azo pigment in view of photosensitivity.

The binding resin to be used for the charge generation layer in the function-separated photoreceptor may, for example, be a polyvinyl acetal type resin such as a polyvinyl butyral resin, a polyvinyl formal resin or a partially acetalized polyvinyl butyral resin having a part of butyral modified by formal, acetal or the like, a polyarylate resin, a polycarbonate resin, a polyester resin, a modified ether type polyester resin, a phenoxy resin, a polyvinyl chloride resin, a polyvinylidene chloride resin, a polyvinyl acetate resin, a polystyrene resin, an acrylic resin, a methacrylic resin, a polyacrylamide resin, a polyamide resin, a polyvinyl pyridine resin, a cellulose type resin, a polyurethane resin, an epoxy resin, a silicone resin, a polyvinyl alcohol resin, a polyvinylpyrrolidone resin, casein, a vinyl chloride/vinyl acetate type copolymer such as a vinyl chloride/vinyl acetate copolymer, a hydroxy-modified vinyl chloride/vinyl acetate copolymer, a carboxyl-modified vinyl chloride/vinyl acetate copolymer or a vinyl chloride/vinyl acetate/maleic anhydride copolymer, an insulating resin such as a styrene/butadiene copolymer, a vinylidene chloride/acrylonitrile copolymer, a styrene/alkyd resin, a silicon/alkyd resin or a phenol/formaldehyde resin, or an organic photoconductive polymer such as poly-N-vinylcarbazole, polyvinyl anthracene or polyvinyl perylene. The binding resin may be selected from these resins but is not limited to such polymers. Further, such binding resins may be used alone or as a mixture of two or more.

The solvent or the dispersion medium to be used for preparation of the coating liquid, in which the binding resin is dissolved, may, for example, be a saturated aliphatic solvent such as pentane, hexane, octane or nonane; an aromatic solvent such as toluene, xylene or anisole; a halogenated aromatic solvent such as chlorobenzene, dichlorobenzene or chloronaphthalene; an amide solvent such as dimethylformamide or N-methyl-2-pyrrolidone; an alcohol solvent such as methanol, ethanol, isopropanol, n-butanol or benzyl alcohol; an aliphatic polyhydric alcohol such as glycerol or polyethylene glycol; a chain or cyclic ketone solvent such as acetone, cyclohexanone or methyl ethyl ketone; an ester solvent such as methyl formate, ethyl acetate or n-butyl acetate; a halogenated hydrocarbon solvent such as methylene chloride, chloroform or 1,2-dichloroethane; a chain or cyclic ether solvent such as diethyl ether, dimethoxyethane, tetrahydrofuran, 1,4-dioxane, methyl cellosolve or ethyl cellosolve; an aprotic polar solvent such as acetonitrile, dimethyl sulfoxide, sulfolane or hexamethylphosphoric triamide; a nitrogen-containing compound such as n-butylamine, isopropanolamine, diethylamine, triethanolamine, ethylenediamine, triethylenediamine or triethylamine; a mineral oil such as ligroin; or water. The solvent or the dispersion medium is preferably one in which the after-mentioned undercoat layer is insoluble. Further, they may be used alone or in combination of two or more.

In the charge generation layer of the function-separated photoreceptor, the blend ratio (weight) of the charge generation substance to the binding resin is from 10 to 1,000 parts by weight, preferably from 30 to 500 parts by weight per 100 parts by weight of the binder resin, and the film thickness is usually from 0.1 to 10 μm, preferably from 0.15 to 0.6 μm. If the ratio of the charge generation substance is too high, stability of the coating liquid tends to decrease due to problems such as agglomeration of the charge generation substance, and if it is too low, the sensitivity as the photoreceptor tends to decrease, and accordingly the ratio is preferably within the above range. As a method of dispersing the charge generation substance, for example, a known dispersion method such as a ball mill dispersion method, an attritor dispersion method or a sand mill dispersion method may be employed. On that occasion, it is preferred to make the particles be fine to particle sizes of at most 0.5 μm, preferably at most 0.3 μm, more preferably at most 0.15 μm.

As the electroconductive substrate to be used for the photoreceptor, a metallic material such as aluminum, an aluminum alloy, stainless steel, copper or nickel, a resin material in which an electroconductive powder of e.g. a metal, carbon or tin oxide has been added for ensuring an electroconductivity, a resin, glass or paper with an electroconductive material such as aluminum, nickel or ITO (indium tin oxide) deposited or coated on its surface, may, for example, be mainly used. It is used, for example, in a drum form, sheet form, belt form, or the like. One obtained by coating an electroconductive material having an appropriate resistance value on an electroconductive substrate made of a metallic material for controlling the conductivity and the surface properties, or covering the defects, may also be used.

In a case where a metallic material such as an aluminum alloy is used as the electroconductive substrate, it may be used after subjected to an anodic oxidation treatment. When it is subjected to the anodic oxidation treatment, it is preferably subjected to a sealing treatment by a known method.

An anodic oxide film is formed by the anodic oxidation treatment in an acidic bath of e.g. chromic acid, sulfuric acid, oxalic acid, boric acid or sulfamic acid, and an anodic oxidation treatment in sulfuric acid brings better results. In the case of anodic oxidation in sulfuric acid, the conditions are preferably set so that the sulfuric acid concentration is from 100 to 300 g/L, the dissolved aluminum concentration is from 2 to 15 g/L, the liquid temperature is from 15 to 30° C., the electrolysis voltage is from 10 to 20 V, and the current density is from 0.5 to 2 A/dm². However, the conditions are not limited to the above conditions.

It is preferred to apply a sealing treatment to the anodic oxide film thus formed. The sealing treatment may be carried out by a conventional method, and for example, a low temperature sealing treatment by immersion in an aqueous solution containing nickel fluoride as the main component or a high temperature sealing treatment by immersion in an aqueous solution containing nickel acetate as the main component, is preferably applied.

In the case of the above low temperature sealing treatment, the concentration of the aqueous nickel fluoride solution used may optionally be selected, and more preferred results will be obtained when it is within a range of from 3 to 6 g/L, preferably from 4 to 6 g/L. Further, in order to smoothly carry out the sealing treatment, the treatment temperature is usually from 25 to 40° C., preferably from 30 to 35° C., and the pH of the aqueous nickel fluoride solution is usually from 4.5 to 6.5, preferably from 5.5 to 6.0. As a pH adjustor, oxalic acid, boric acid, formic acid, acetic acid, sodium hydroxide, sodium acetate or ammonium water may, for example, be used. The treatment time is from 1 to 3 minutes, preferably from 2 to 3 minutes per 1 μm thickness of the film. Further, in order to further improve film physical properties, cobalt fluoride, cobalt acetate, nickel sulfate, a surfactant or the like may be preliminarily added to the aqueous nickel fluoride solution. Then, washing with water and drying are carried out to complete the low temperature sealing treatment.

In the case of the high temperature sealing treatment, as a sealing agent, an aqueous solution of a metal salt such as nickel acetate, cobalt acetate, lead acetate, nickel-cobalt acetate or barium nitrate may, for example, be used, and it is particularly preferred to use nickel acetate. In the case of using an aqueous nickel acetate solution, the concentration is preferably within a range of from 5 to 20 g/L, particularly preferably from 10 to 15 g/L. The treatment temperature is usually from 80 to 100° C., preferably from 90 to 98° C., and the pH of the aqueous nickel acetate solution is preferably from 5.0 to 6.0. Here, as a pH adjustor, ammonia water, sodium acetate or the like may be used. The treatment time is usually at least 10 minutes, preferably at least 20 minutes. In this case also, in order to improve the film physical properties, sodium acetate, an organic carboxylic acid, an anionic surfactant or a nonionic surfactant may, for example, be added to the aqueous nickel acetate solution. Then, washing with water and drying are carried out to complete the high temperature sealing treatment. In a case where the average film thickness is thick, stronger sealing conditions such as a high concentration of the sealing liquid and a treatment at a higher temperature for a longer time are required. Thus, not only the productivity tends to be poor but also surface defects such as stain, dirt or dust attachment are likely to occur on the surface of the film. From such a viewpoint, the average film thickness of the anodic oxide film is usually preferably at most 20 μm, particularly preferably at most 7 μm.

The substrate surface may be either smooth, or roughened by using a particular cutting method or carrying out a polishing treatment. Further, it may also be one roughened by mixing particles with an appropriate particle size in the material constituting the substrate. Further, to lower the cost, a drawn tube without cutting treatment may be used as it is. Particularly, it is preferred to use a non-cut aluminum substrate obtained by drawing, impact extrusion, ironing or the like, since attachments such as stain or foreign matters, small scratches, etc. on the surface are eliminated by the treatment, and a uniform and clean substrate will be obtained.

An undercoat layer may be provided between the electroconductive substrate and the after-mentioned photosensitive layer for improving the adhesion, the blocking tendency, etc. The undercoat layer may, for example, be a resin, or one obtained by dispersing particles of a metal oxide or the like in a resin.

Examples of the metal oxide particles to be used for the undercoat layer include particles of a metal oxide including one metallic element such as titanium oxide, aluminum oxide, silicon oxide, zirconium oxide, zinc oxide or iron oxide, and particles of a metal oxide including a plurality of metallic elements such as calcium titanate, strontium titanate or barium titanate. These particles of a metal oxide may be used alone or as a mixture of a plurality thereof. Among these metal oxide particles, titanium oxide or aluminum oxide is preferred, and titanium oxide is particularly preferred. The titanium oxide particles may be surface-treated by an inorganic substance such as tin oxide, aluminum oxide, antimony oxide, zirconium oxide or silicon oxide, or an organic substance such as stearic acid, polyol or silicone. Any crystalline form of the titanium oxide particles such as rutile-, anatase-, brookite-, or amorphous-form may be used. A plurality of crystalline forms may also be included therein.

Further, although the particle size of the metal oxide particles usable may be various ones, among them, when the average of maximum sizes of optional ten particles as observed in a SEM photograph is regarded as the primary particle size, the average primary particle size is preferably at least 10 nm and at most 100 nm, particularly preferably at least 10 nm and at most 50 nm in view of the characteristics and the solution stability.

The undercoat layer is preferably formed into the structure in which the metal oxide particles are dispersed in the binder resin. The binder resin to be used for the undercoat layer may, for example, be a known binding resin such as an epoxy resin, a polyethylene resin, a polypropylene resin, an acrylic resin, a methacrylic resin, a polyamide resin, a vinyl chloride resin, a vinyl chloride resin, a vinyl acetate resin, a phenol resin, a polycarbonate resin, a polyurethane resin, a polyimide resin, a vinylidene chloride resin, a polyvinyl acetal resin, a vinyl chloride/vinyl acetate copolymer, a polyvinyl alcohol resin, a polyurethane resin, a polyacrylic resin, a polyacrylamide resin, a polyvinylpyrrolidone resin, a polyvinylpyridine resin, a water soluble polyester resin, a cellulose ester resin such as nitrocellulose, a cellulose ether resin, casein, gelatin, polyglutamic acid, starch, starch acetate, aminostarch, an organic zirconium compound such as a zirconium chelate compound or a zirconium alkoxide compound, an organic titanyl compound such as a titanyl chelate compound or a titanyl alkoxide compound, or a silane coupling agent. They may be used alone or as cured with a curing agent. Among them, preferred is an alcohol soluble copolymerized polyamide, modified polyamide or the like, which shows favorable dispersibility and coating properties.

The addition amount of the inorganic particles based on the binder resin to be used for the undercoat layer may be optional, and is preferably from 10 to 500 wt %, particularly preferably from 50 to 400 wt %, in view of stability and the coating properties of the dispersion liquid.

The thickness of the undercoat layer is optional, and is usually from 0.01 to 30 μm, preferably from 0.1 to 20 μm in view of photoreceptor characteristics and the coating properties. Further, the undercoat layer may contain pigment particles, resin particles or the like for the purpose of preventing image defects.

In formation of the charge transport layer of the function-separated photoreceptor having the charge generation layer and the charge transport layer, and the photosensitive layer of the monolayer type photoreceptor, a binder resin is used to secure strength of the film. The charge transport layer of the function-separated photoreceptor can be obtained by applying and drying a coating fluid obtained by dissolving or dispersing the charge transport substance and the binder resin in a solvent, and the photosensitive layer of the monolayer type photoreceptor can be obtained by applying and drying a coating liquid obtained by dissolving or dispersing the charge generation substance, the charge transport substance and the binder resin in a solvent. The binder resin may, for example, be a polymer or copolymer of a vinyl compound such as a butadiene resin, a styrene resin, a vinyl acetate resin, a vinyl chloride resin, an acrylic ester resin, a methacrylic ester resin, a vinyl alcohol resin or an ethyl vinyl ether, a polyvinyl butyral resin, a polyvinyl formal resin, a partially modified polyvinyl acetal, a polycarbonate resin, a polyester resin, a polyarylate resin, a polyamide resin, a polyurethane resin, a cellulose ester resin, a phenoxy resin, a silicone resin, a silicon/alkyd resin or a poly-N-vinylcarbazole resin. Such binder resins may be modified by e.g. a silicon reagent. Among the above binder resins, particularly preferred is a polycarbonate resin or a polyarylate resin.

Among the polycarbonate resins and the polyarylate resins, preferred is a polycarbonate resin or polyarylate resin containing a bisphenol or biphenol component having the following structural formula in view of the sensitivity and the residual potential, and more preferred is a polycarbonate resin in view of mobility.

Structures of the bisphenols and the biphenols to be suitably used for the polycarbonate resin are exemplified below. However, these examples are shown to define the scope of the present invention, and the present invention is not limited to the exemplified structures without departing from the spirit and scope of the present invention:

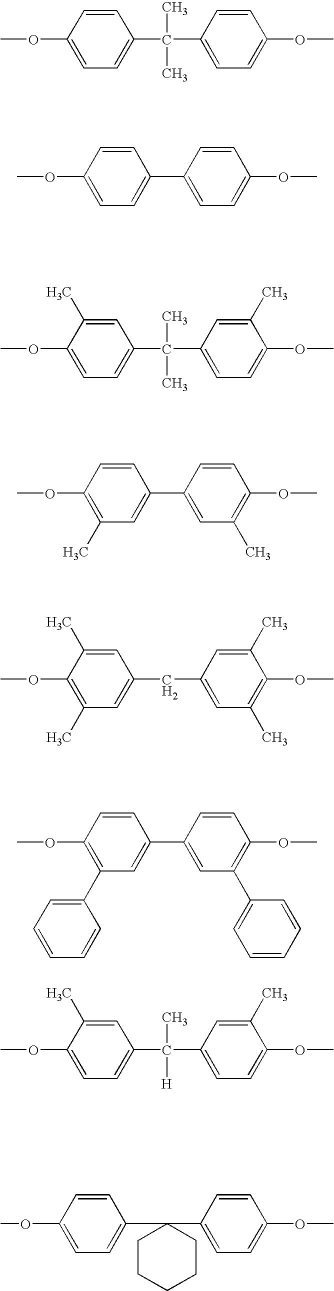

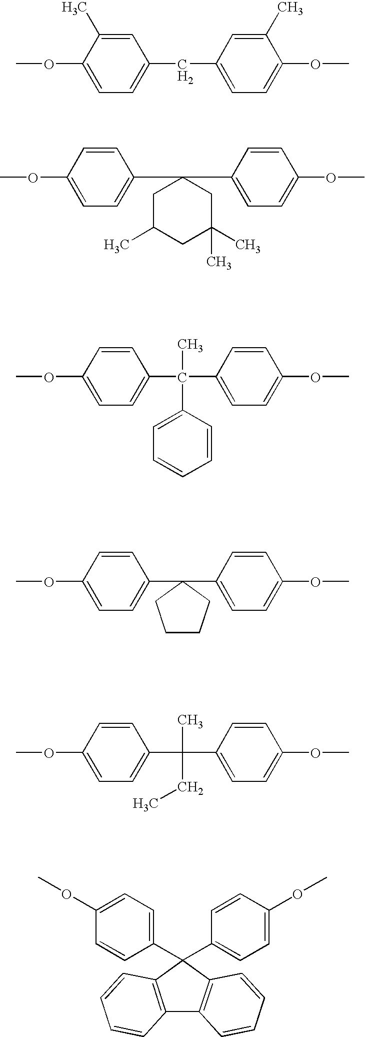

Such a structural component may be crosslinked by heat, light or the like using a proper curing agent. Further, the binder resins may be used as a blend of two or more. The viscosity average molecular weight of the polycarbonate resin or the polyarylate resin is not particularly limited, and it is usually at least 10,000, preferably at least 15,000, more preferably at least 20,000, and it is usually at most 300,000, preferably at most 200,000, more preferably at most 100,000. If the viscosity average molecular weight is excessively low, mechanical strength of the photosensitive layer tends to decrease, such being impractical. Further, if the viscosity average molecular weight is excessively high, it will be difficult to form the photosensitive layer in a proper thickness by coating.

As the charge transport substance, the above hydrazone compound is used. The hydrazone compound may be used alone or in combination with another charge transport substance. The charge transport substance to be used in combination is not particularly limited so long as it is a known substance, and it may, for example, be an electron-withdrawing substance such as an aromatic nitro compound such as 2,4,7-trinitrofluorenone, a cyano compound such as tetracyanoquinodimethane or a quinone compound such as diphenoquinone, a heterocyclic compound such as a carbazole derivative, an indole derivative, an imidazole derivative, an oxazole derivative, a pyrazole derivative, a thiadiazole derivative or a benzofuran derivative, or an electron-donative substance such as an aniline derivative, a hydrazone derivative, an aromatic amine derivative, a stilbene derivative, a butadiene derivative or an enamine derivative. An electron-donative substance comprising a plurality of such compounds bonded or a polymer having a group comprising such a compound in its main chain or side chains may also be mentioned. Among them, preferred is a carbazole derivative, an aromatic amine derivative, a stilbene derivative, a butadiene derivative, an enamine derivative or one having a plurality of such compounds bonded.

As the ratio of the charge transport substance to the binder resin, in the case of both the monolayer type photoreceptor and the lamination type photoreceptor (function-separated photoreceptor), it is usually at least 20 parts by weight per 100 parts by weight of the binder resin, preferably at least 30 parts by weight from the viewpoint of reduction of the residual potential, and more preferably at least 40 parts by weight from the viewpoint of the stability at the time of repeated use and the charge mobility. Further, it is usually at most 150 parts by weight from the viewpoint of the thermal stability of the photosensitive layer, preferably at most 120 parts by weight from the viewpoint of the compatibility between the charge transport substance and the binder resin, more preferably at most 100 parts by weight from the viewpoint of the printing resistance, and especially preferably at most 80 parts by weight from the viewpoint of scar resistance.

Further, in the case of the lamination type photoreceptor, the thickness is usually from 5 to 50 μm, and it is preferably from 5 to 45 μm from the viewpoint of the prolongation of life and image stability, more preferably from 5 to 30 μm from the viewpoint of high definition.

To the photosensitive layer, known additives such as an antioxidant, a plasticizer, an ultraviolet absorber, an electron-withdrawing compound, a leveling agent and a visible light shielding agent may be incorporated for the purpose of improving the film-forming properties, flexibility, coating properties, stain resistance, gas resistance, lightfastness, etc.

In the case of the monolayer type photoreceptor, in the charge transport layer in the above-described blend ratio, the above oxytitanium phthalocyanine is further dispersed. In such a case, the volume average particle size of the oxytitanium phthalocyanine is required to be sufficiently small, and it is preferably at most 1 μm, more preferably at most 0.5 μm. If the amount of the oxytitanium phthalocyanine dispersed in the photosensitive layer is too small, no sufficient sensitivity will be obtained, and if it is too large, drawbacks such as a decrease in the triboelectricity and a decrease in the sensitivity may occur, and accordingly it is preferably from 0.1 to 50 wt %, more preferably from 1 to 20 wt %. In the case of the monolayer type photoreceptor, the thickness is usually from 5 to 100 μm, preferably from 10 to 50 μm.

In the case of the lamination type photoreceptor or the monolayer type photoreceptor, a protective layer may be provided on the outermost layer for the purpose of preventing abrasion of the photosensitive layer or of preventing and reducing deterioration of the photosensitive layer due to a discharging substance or the like generated from a charger or the like. The protective layer may usually be formed by incorporating an electroconductive material in a proper binding resin or by using a copolymer using a compound having charge transport performance such as a triphenylamine skeleton as disclosed in JP-A-9-190004. The electroconductive material may, for example, be an aromatic amino compound such as TPD (N,N′-diphenyl-N,N′-bis(m-tolyl)benzidine), or a metal oxide such as antimony oxide, indium oxide, tin oxide, titanium oxide, tin oxide-antimony oxide, aluminum oxide or zinc oxide, but it is not limited thereto. The binding resin to be used for the protective layer may, for example, be a known resin such as a polyamide resin, a polyurethane resin, a polyester resin, an epoxy resin, a polyketone resin, a polycarbonate resin, a polyvinyl ketone resin, a polystyrene resin, a polyacrylamide resin or a siloxane resin. Further, a copolymer of a skeleton having charge transport performance such as a triphenylamine skeleton as disclosed in JP-A-9-190004 with the above resin may also be used. The protective layer is preferably constituted to have an electrical resistance of from 10⁹ to 10¹⁴ Ω·cm. If the electrical resistance is higher than 10¹⁴ Ω·cm, the residual potential tends to increase, and an image to be obtained tends to have a large amount of foggings, and if it is lower than 10⁹ Ω·cm, blurring of an image and the decrease in the resolution tend to occur. Further, the protective layer must be constituted not substantially to prevent transmission of light to be irradiated for image exposure.

Further, the surface layer may contain a fluororesin, a silicone resin, a polyethylene resin or the like for the purpose of reducing the abrasion resistance and abrasion on the surface of the photoreceptor, of increasing the transfer efficiency of the toner from the photoreceptor to the transfer belt and paper, and the like. Further, particles of such a resin or particles of an inorganic compound may be contained.

The coating liquid to be obtained by the above method is used, in the case of the monolayer type photoreceptor and the charge transport layer of the function-separated photoreceptor, at a solid content concentration of usually from 5 to 40 wt %, preferably from 10 to 35 wt %. The viscosity of the coating liquid is usually from 10 to 500 mPa·s, preferably from 50 to 400 mPa·s. In the case of the charge generation layer of the function-separated photoreceptor, the solid content concentration is usually from 0.1 to 15 wt %, preferably from 1 to 10 wt %. The viscosity of the coating liquid is usually from 0.01 to 20 mPa·s, preferably from 0.1 to 10 mPa·s.

The respective layers constituting the photoreceptor are formed by sequentially applying coating liquids obtained by the above method to the substrate by a known coating method repeatedly carrying out coating and drying steps for the respective layers.

The method of applying the coating liquid may, for example, be a dip coating method, a spray coating method, a spinner coating method, a bead coating method, a wire bar coating method, a blade coating method, a roller coating method, an air knife coating method or a curtain coating method, and another known coating method may also be used.

As drying of the coating liquid, it is preferably dried to the touch at room temperature and then dried by heating at a temperature of from 30 to 200° C. from one minute to 2 hours with or without air blasting. Further, the heating temperature may be constant or may be changed during drying.

### (Image Forming Apparatus, Cartridge)

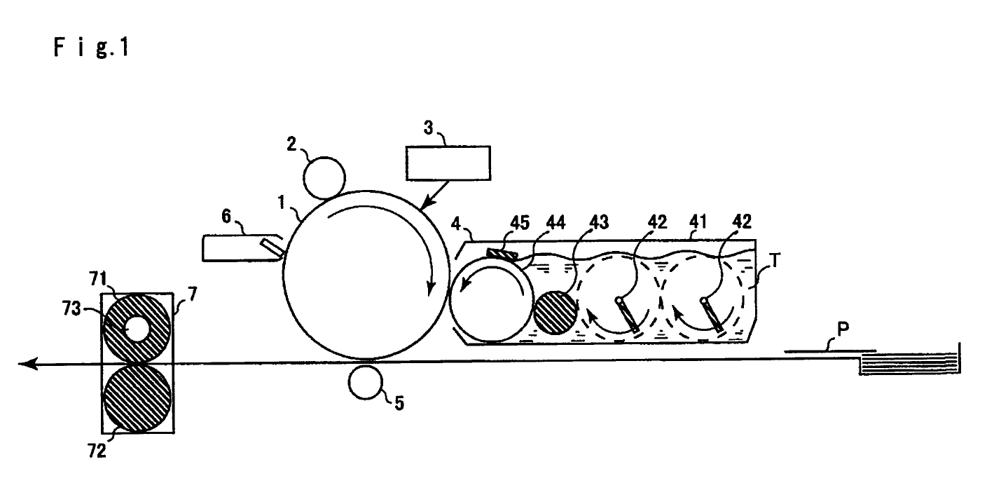

Now, the embodiment of an image forming apparatus employing the electrophotographic photoreceptor of the present invention (image forming apparatus of the present invention) will be explained with reference to FIG. 1 illustrating a structure of a substantial part of the apparatus. However, the embodiment is not limited to the following explanation, and various changes and modifications can be made without departing from the spirit and scope of the present invention.

As shown in FIG. 1, the image forming apparatus comprises an electrophotographic photoreceptor 1, a charging apparatus 2, an exposure apparatus 3 and a developing apparatus 4, and it further has a transfer apparatus 5, a cleaning apparatus 6 and a fixing apparatus 7 as the case requires.

The electrophotographic photoreceptor 1 is not particularly limited so long as it is the above-described electrophotographic photoreceptor of the present invention, and in FIG. 1, as one example thereof, a drum form photoreceptor comprising a cylindrical electroconductive substrate and the above-described photosensitive layer formed on the surface of the substrate is shown. Along the outer peripheral surface of the electrophotographic photoreceptor 1, the charging apparatus 2, the exposure apparatus 3, the developing apparatus 4, the transfer apparatus 5 and the cleaning apparatus 6 are disposed.

The charging apparatus 2 is to charge the electrophotographic photoreceptor 1, and uniformly charges the surface of the electrophotographic photoreceptor 1 to a predetermined potential. As the charging apparatus 2, a corona charging apparatus such as corotron or scorotron, a direct charging apparatus (contact charging apparatus) to charge by contacting a voltage-applied direct charging member to the surface of the photoreceptor, or the like is mainly used. The direct charging apparatus may, for example, be a contact charger such as a charging roller or a charging brush. In FIG. 1, as one example of the charging apparatus 2, a roller type charging apparatus (charging roller) is shown. As a direct charging means, either charging involving aerial discharge or injection charging without aerial discharge is possible. Further, the voltage to be applied during charging may be only a direct voltage or may be an alternating voltage superposed to a direct voltage.

The type of the exposure apparatus 3 is not particularly limited so long as the electrophotographic photoreceptor 1 is exposed to form an electrostatic latent image on the photosensitive surface of the electrophotographic photoreceptor 1. Specific examples thereof include a halogen lamp, a fluorescent lamp, a laser such as a semiconductor laser or a He—Ne laser and LED. Further, exposure may be carried out by a photoreceptor internal exposure method. The light for the exposure is optional, and exposure may be carried out with a monochromatic light having a wavelength of 780 nm, a monochromatic light slightly leaning to short wavelength side having a wavelength of from 600 to 700 nm, a short wavelength monochromatic light having a wavelength of from 380 to 500 nm or the like. However, with light having a short wavelength less than 500 nm, no sufficient light writing is possible due to absorption by the hydrazone compound of the present invention in some cases, and accordingly it is preferred to carry out exposure by a monochromatic light having a wavelength of from 500 to 800 nm.

The type of the developing apparatus 4 is not particularly limited, and an optional apparatus of e.g. a dry development method such as cascade development, single component insulating toner development, single component conductive toner development or two component magnetic brush development or a wet development method may be used. In FIG. 1, the developing apparatus 4 comprises a developing tank 41, an agitator 42, a supply roller 43, a developing roller 44 and a control member 45, and a toner T is stored in the developing tank 41. Further, as the case requires, the developing apparatus 4 may have a supply apparatus (not shown) which supplies the toner T. The supply apparatus is constituted so that the toner T can be supplied from a container such as a bottle or a cartridge.

The supply roller 43 is formed from e.g. an electrically conductive sponge. The developing roller 44 is e.g. a metal roll of e.g. iron, stainless steel, aluminum or nickel or a resin roll having such a metal roll covered with a silicon resin, a urethane resin, a fluororesin or the like. A smoothing treatment or a roughening treatment may be applied to the surface of the developing roller 44 as the case requires.

The developing roller 44 is disposed between the electrophotographic photoreceptor 1 and the supply roller 43, and is in contact with each of the electrophotographic photoreceptor 1 and the supply roller 43. The supply roller 43 and the developing roller 44 are rotated by a rotation driving mechanism (not shown). The supply roller 43 supports the stored toner T and supplies it to the developing roller 44. The developing roller 44 supports the toner T supplied by the supply roller 43 and brings it into contact with the surface of the electrophotographic photoreceptor 1.

The control member 45 is formed by a resin blade of e.g. a silicone resin or a urethane resin, a metal blade of e.g. stainless steel, aluminum, copper, brass or phosphor bronze, or a blade having such a metal blade covered with a resin. The control member 45 is in contact with the developing roller 44, and is pressed under a predetermined force to the side of the developing roller 44 by e.g. a spring (general blade linear pressure is from 5 to 500 g/cm). As the case requires, the control member 45 may have a function to charge the toner T by means of frictional electrification with the toner T.

The agitator 42 is rotated by a rotation driving mechanism, and stirs the toner T and transports the toner T to the supply roller 43 side. A plurality of agitators 42 with different blade shapes, sizes or the like may be provided.

The type of the toner T is optional, and in addition to a powdery toner, a chemical toner obtained by e.g. suspension granulation, suspension polymerization or emulsion polymerization agglomeration, may be used. In the case of the chemical toner, preferred is one having small particle sizes of from about 4 to about 8 μm, and with respect to the shape of particles of the toner, nearly spherical particles and particles which are not spherical, such as potato-shape particles, may be variously used. Particularly, a polymerized toner is excellent in charging uniformity and transfer properties, and is favorably used to obtain a high quality image.

The type of the transfer apparatus 5 is not particularly limited, and an apparatus of optional method such as an electrostatic transfer method such as corona transfer, roller transfer or belt transfer, a pressure transfer method or an adhesive transfer method may be used. In this case, the transfer apparatus 5 comprises a transfer charger, a transfer roller, a transfer belt and the like which are disposed to face the electrophotographic photoreceptor 1. The transfer apparatus 5 applies a predetermined voltage (transfer voltage) at a polarity opposite to the charge potential of the toner T and transfers a toner image formed on the electrophotographic photoreceptor 1 to a recording paper (paper sheet, medium) P.

The cleaning apparatus 6 is not particularly limited, and an optional cleaning apparatus such as a brush cleaner, a magnetic brush cleaner, an electrostatic brush cleaner, a magnetic roller cleaner or a blade cleaner may be used. The cleaning apparatus 6 is to scrape away the remaining toner attached to the photoreceptor 1 by a cleaning member and to recover the remaining toner. If there is no or little remaining toner, the cleaning apparatus 6 is not necessarily provided.

The fixing apparatus 7 comprises an upper fixing member (fixing roller) 71 and a lower fixing member (fixing roller) 72, and a heating apparatus 73 is provided in the interior of the fixing member 71 or 72. FIG. 1 illustrates an example wherein the heating apparatus 73 is provided in the interior of the upper fixing member 71. As each of the upper and lower fixing members 71 and 72, a known heat fixing member such as a fixing roll comprising a metal cylinder of e.g. stainless steel or aluminum covered with a silicon rubber, a fixing roll further covered with Teflon (registered trademark) or a fixing sheet may be used. Further, each of the fixing members 71 and 72 may have a structure to supply a release agent such as a silicone oil so as to improve the releasability, or may have a structure to forcibly apply a pressure to each other by e.g. a spring.

The toner transferred on the recording paper P is heated to a molten state when it passes through the upper fixing member 71 and the lower fixing member 72 heated to a predetermined temperature, and then cooled after passage and fixed on the recording paper P.

The type of the fixing apparatus is also not particularly limited, and one used in this case, and further, a fixing apparatus by an optional method such as heated roller fixing, flash fixing, oven fixing or pressure fixing may be provided.

In the image forming apparatus constituted as mentioned above, recording of an image is carried out in accordance with the following method (image forming method of the present invention).

Namely, the surface (photosensitive surface) of the photoreceptor 1 is charged to a predetermined potential (−600 V for example) by the charging apparatus 2. In this case, it may be charged by a direct voltage or may be charged by superposing an alternating voltage to a direct voltage.

Then, the charged photosensitive surface of the photoreceptor 1 is exposed by means of the exposure apparatus 3 in accordance with the image to be recorded to form an electrostatic latent image on the photosensitive surface. Then, the electrostatic latent image formed on the photosensitive surface of the photoreceptor 1 is developed by the developing apparatus 4.

The developing apparatus 4 forms the toner T supplied by the supply roller 43 into a thin layer by the control member (developing blade) 45 and at the same time, charges it to a predetermined polarity (in this case, the same polarity as the charge potential of the photoreceptor 1 and negative polarity) by means of frictional electrification, transfers it while supporting it by the developing roller 44 and brings it into contact with the surface of the photoreceptor 1.

When the charged toner T supported by the developing roller 44 is brought into contact with the surface of the photoreceptor 1, a toner image corresponding to the electrostatic latent image is formed on the photosensitive surface of the photoreceptor 1. Then, the toner image is transferred to the recording paper P by the transfer apparatus 5. Then, the toner remaining on the photosensitive surface of the photoreceptor 1 without being transferred is removed by the cleaning apparatus 6.

After the toner image is transferred to the recording paper P, the recording paper P is made to pass through the fixing apparatus 7 so that the toner image is heat fixed on the recording paper P, whereby an image is finally obtained.

The image forming process is a repetitive process and accordingly the previously formed image appears at the time of the next image formation in some cases. For example, in a case where a halftone image is printed after a character image is printed, a phenomenon such that the previously printed characters appear at the halftone image portion, a so-called memory (ghost) phenomenon occurs in some cases. This memory phenomenon includes a positive memory phenomenon such that the image appears at a higher density and a negative memory phenomenon such that the density decreases.

Detailed mechanism of the memory phenomenon on an image has been unclear in many aspects and has not completely been understood yet. However, the memory phenomenon is reduced, for example, by a structure capable of carrying out a charge removal step in addition to the above-described structure, and accordingly the charge removal step is employed in many image forming apparatus. The charge removal step is a step of carrying out charge removal of the electrophotographic photoreceptor by exposing the electrophotographic photoreceptor, and as a charge removal apparatus, a fluorescent lamp or LED may, for example, be used. Further, the light used in the charge removal step, in terms of intensity, is a light having an exposure energy at least three times the exposure light in many cases. However, the electrophotographic photoreceptor of the present invention, characterized in that the memory phenomenon very hardly occurs, is suitable for formation of a favorable image particularly by an image forming apparatus comprising no charge removal step.

Further, the image forming apparatus may have a further modified structure, and it may have, for example, a structure capable of carrying out a step such as a pre-exposure step or a supplementary charging step, a structure of carrying out offset printing, or a full color tandem structure employing plural types of toners.

The electrophotographic photoreceptor 1 alone or in combination of one or more elements among the charging apparatus 2, the exposure apparatus 3, the developing apparatus 4, the transfer apparatus 5, the cleaning apparatus 6 and the fixing apparatus 7 may be formed into an integrated cartridge (hereinafter sometimes referred to as an “electrophotographic photoreceptor cartridge”). The electrophotographic photoreceptor cartridge may be designed to be removable from an image forming apparatus main body such as a copying machine or a laser beam printer. In such a case, using a cartridge case designed to be removable from the image forming apparatus, the electrophotographic photoreceptor 1 alone or in combination with the above-described element is contained in and supported by the cartridge case, thereby to obtain an electrophotographic photoreceptor cartridge. By such a structure, for example, when the electrophotographic photoreceptor 1 or another member is deteriorated, the electrophotographic photoreceptor cartridge is removed from the image forming apparatus main body and another new electrophotographic photoreceptor cartridge is attached to the image forming apparatus main body, whereby maintenance of the image forming apparatus will be easy.

### EXAMPLES

Now, the present invention will be described in further detail with reference to Preparation Examples, Examples and Comparative Examples. However, the following Examples are shown to define the present invention, and the present invention is by no means restricted to the following Examples without departing from the spirit and scope of the present invention.

### (Method of Measuring Powder X-Ray Diffraction Spectrum)

The peaks at Bragg angles (2θ±0.2°) to CuKα characteristic X-ray (wavelength: 1.541 Å) of oxytitanium phthalocyanine crystals specified in the present invention can be measured by any known method. In Examples of the present invention, peaks of the oxytitanium phthalocyanine crystals were specified by carrying out measurement in accordance with the following method. To measure a powder X-ray diffraction spectrum, as the measuring apparatus, PW1700 manufactured by PANanalytical which is a focusing optics type powder X-ray diffractometer employing CuKα rays as a ray source was used. The measurement conditions were such that X-ray output: 40 kV, 30 mA, scanning range (2θ): 3 to 40°, scan step width: 0.05°, scanning rate: 3.0°/min, divergence slit: 1.0°, scattering slit: 1.0°, receiving slit: 0.2 mm.

### Preparation of Oxytitanium Phthalocyanine

### Preparation Example 1

β-form oxytitanium phthalocyanine was prepared in accordance with “Example for preparation of crude TiOPc” and “Example 1” as disclosed in JP-A-10-7925 in this order.

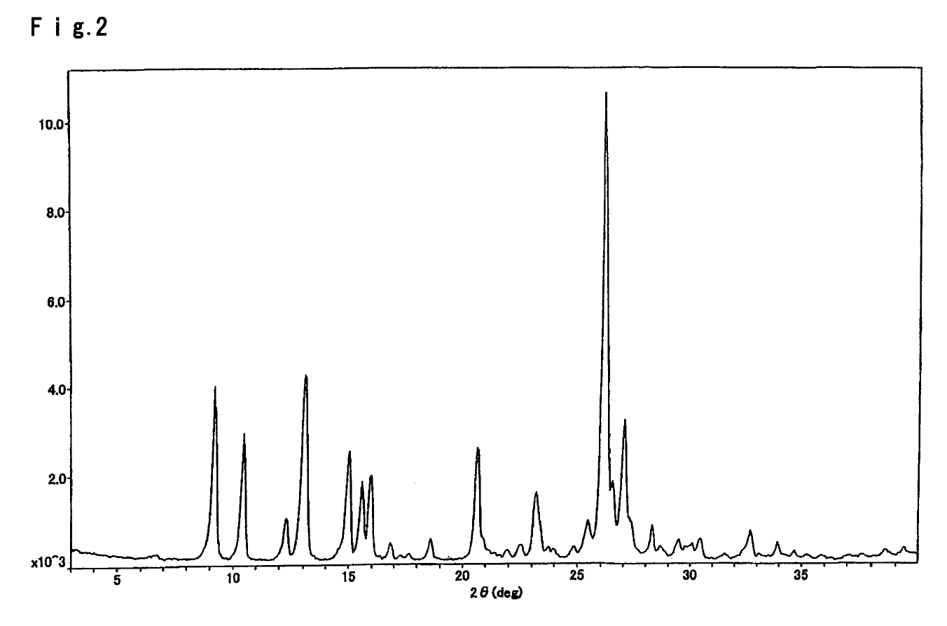

The powder X-ray diffraction spectrum of the obtained oxytitanium phthalocyanine is shown in FIG. 2. The chlorine content contained in the TiOPc crystals was analyzed by the method disclosed in the above “Measurement of chlorine content” and as a result, the chlorine content was at most 0.20 wt % which is at most the lower limit of detection. Further, the mass spectrum intensity ratio of chlorinated oxytitanium phthalocyanine to oxytitanium phthalocyanine was calculated in accordance with the method disclosed in the above “Measurement of mass spectrum” and as a result, it was 0.002.

### Preparation Example 2

Titanyl oxyphthalocyanine was prepared based on the method in Preparation Example 1 as disclosed in JP-A-62-67094. The chlorine content contained in the TiOPc crystals was analyzed by the method disclosed in the above “Measurement of chlorine content” and as a result, the chlorine content was 0.51 wt %. Further, the mass spectrum intensity ratio of chlorinated oxytitanium phthalocyanine to oxytitanium phthalocyanine was calculated in accordance with the method disclosed in the above “Measurement of mass spectrum” and as a result, it was 0.055.

### Preparation Example 3

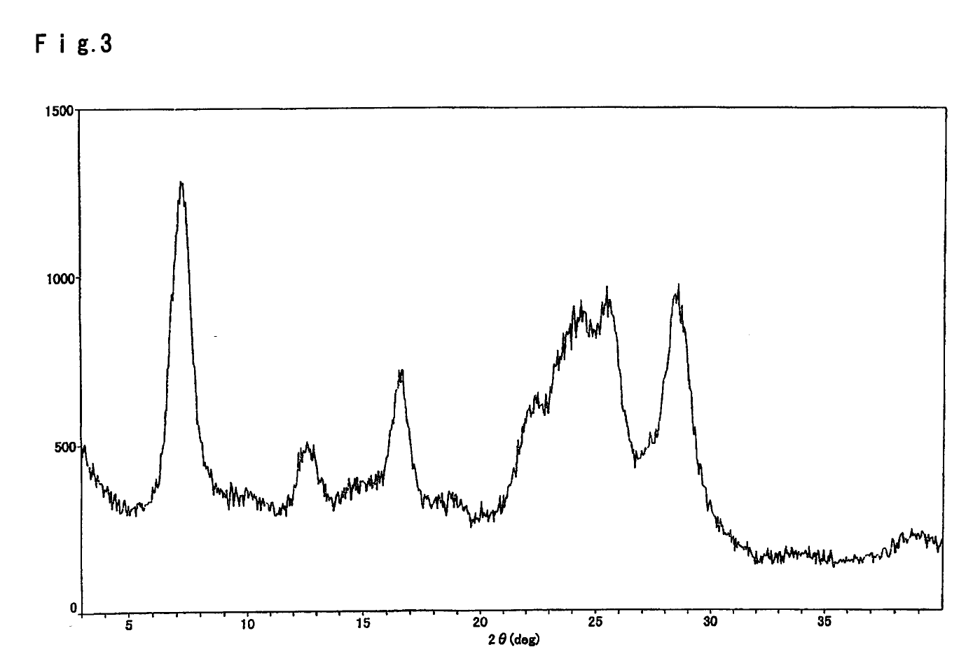

Using the oxytitanium phthalocyanine obtained in Preparation Example 1 as a phthalocyanine crystal precursor, the following operation was carried out. First, 18 parts by weight of the oxytitanium phthalocyanine obtained in Preparation Example 1 was added to 720 parts by weigh of 95 wt % concentrated sulfuric acid cooled to −10° C. or below. On that occasion, it was slowly added so that the internal temperature of the sulfuric acid solution would not exceed −5° C. After completion of addition, the concentrated sulfuric acid solution was stirred at −5° C. or below for 2 hours. After stirring, the concentrated sulfuric acid solution was subjected to filtration through a glass filter, insoluble matters were removed by filtration, and the concentrated sulfuric acid solution was poured in 10,800 parts by weight of ice water to precipitate oxytitanium phthalocyanine, and stirring was carried out for one hour after pouring. After stirring, the solution was subjected to filtration, and the obtained wet cake was washed in 900 parts by weight of water again for one hour, followed by filtration. This washing operation was repeated until the ionic conductivity of the filtrate became 0.5 mS/m to obtain 185 parts by weight of a wet cake of low crystalline oxytitanium phthalocyanine having a powder X-ray diffraction spectrum as shown in FIG. 3 (oxytitanium phthalocyanine content: 9.5 wt %).

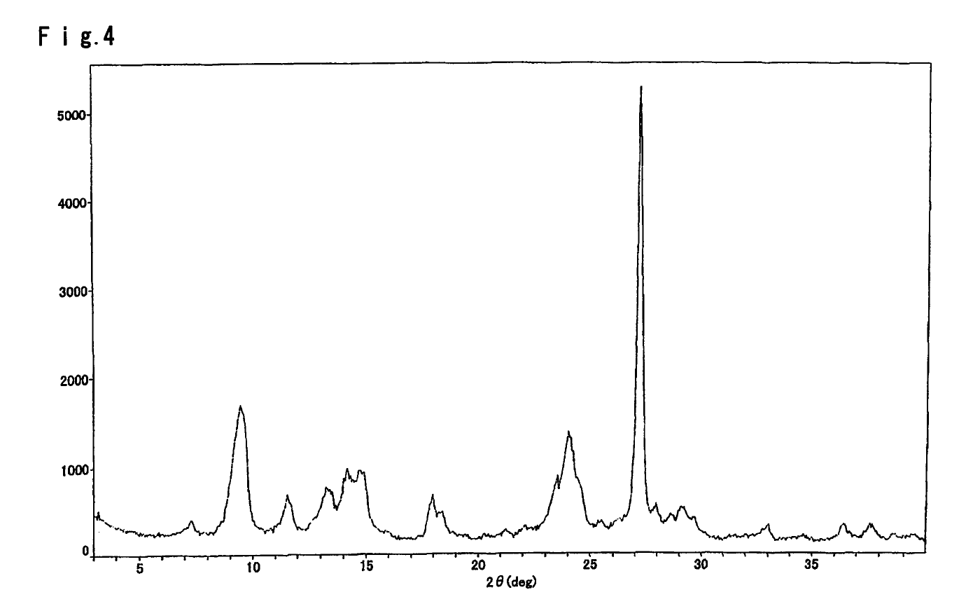

93 Parts by weight of the obtained wet cake of low crystalline oxytitanium phthalocyanine was added to 190 parts by weight of water, followed by stirring at room temperature for 30 minutes. Then, 39 parts by weight of o-dichlorobenzene was added, followed by stirring at room temperature further for one hour. After stirring, water was separated, 134 parts by weight of methanol was added, followed by stirring and washing at room temperature for one hour. After washing, filtration was carried out, stirring and washing were carried out again using 134 parts by weight of methanol for one hour, and then filtration was carried out, and drying by heating by a vacuum drier was carried out to obtain 7.8 parts by weight of oxytitanium phthalocyanine showing diffraction peaks at Bragg angles (2θ±0.2°) of 7.3°, 9.5°, 11.6°, 14.2°, 18.0°, 24.3° and 27.2° in a powder X-ray diffraction spectrum to CuKα characteristic X-ray (wavelength: 1.541 Å) as shown in FIG. 4.

### Preparation Example 4

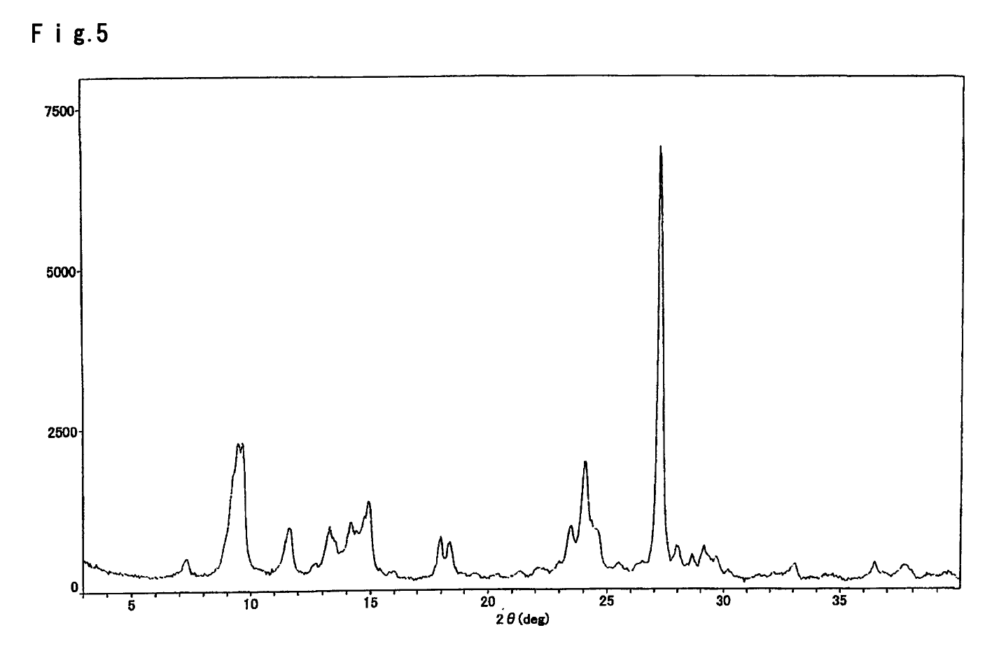

The same operation as in Preparation Example 3 was carried out until the wet cake of low crystalline oxytitanium phthalocyanine was obtained. 46 Parts of the wet cake of low crystalline oxytitanium phthalocyanine was added to 400 parts by weight of tetrahydrofuran, followed by stirring at room temperature for 5 hours. After stirring, filtration was carried out, and drying by heating by a vacuum dryer was carried out to obtain 3.9 parts by weight of oxytitanium phthalocyanine showing chief diffraction peaks at Bragg angles (2θ+0.2°) of 7.3°, 9.5°, 9.7°, 11.6°, 14.2°, 18.0°, 24.2° and 27.2° in a powder X-ray diffraction spectrum to CuKα characteristic X-ray (wavelength: 1.541 Å) as shown in FIG. 5.

### Preparation Example 5

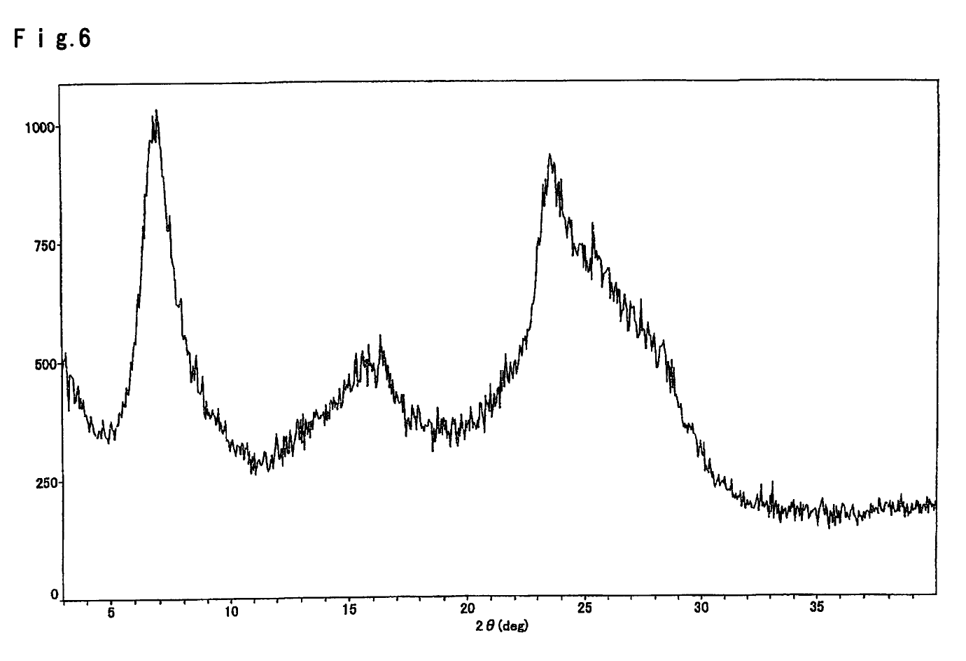

142 Parts by weight of a wet cake of low crystalline oxytitanium phthalocyanine shown in FIG. 6 (oxytitanium phthalocyanine content: 12.8 wt %) was obtained by carrying out the same operation as in Preparation Example 3 until the step of obtaining the wet cake of low crystalline oxytitanium phthalocyanine except that the oxytitanium phthalocyanine obtained in Preparation Example 2 was used as the phthalocyanine crystal precursor.

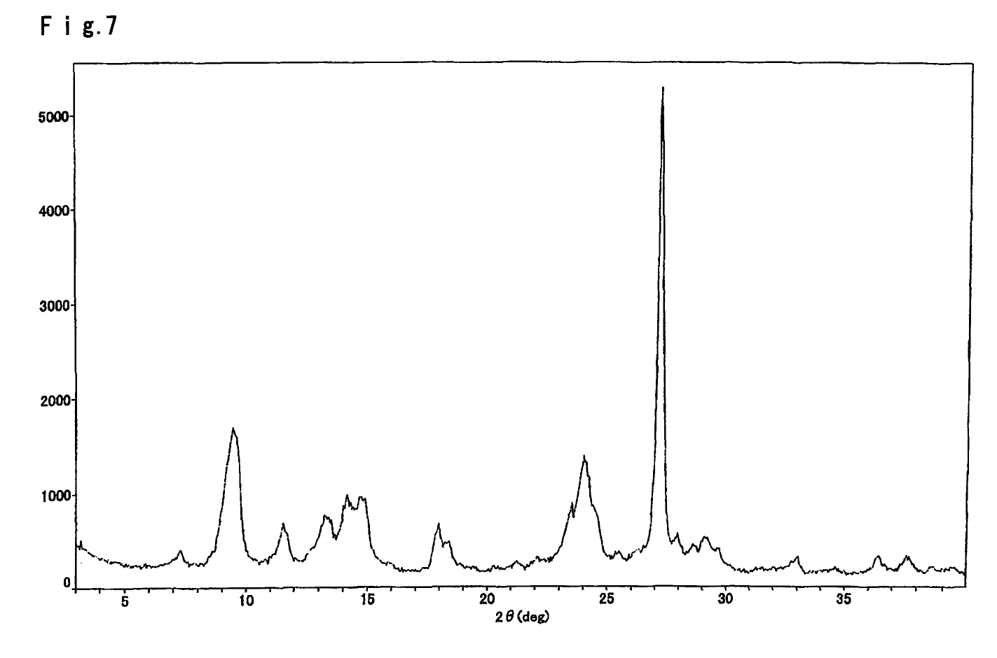

24.8 Parts by weight of the obtained wet cake of low crystalline oxytitanium phthalocyanine was added to 100 parts by weight of water, followed by stirring at room temperature for 30 minutes. Then, 6.2 parts by weight of o-dichlorobenzene was added, followed by stirring at room temperature further for one hour. After stirring, water was separated, and 79 parts by weight of methanol was added, followed by stirring and washing at room temperature for one hour. After washing, filtration was carried out, stirring and washing were carried out again using 79 parts by weight of methanol for one hour, and then filtration was carried out, and drying by heating by a vacuum drier was carried out to obtain 2.5 parts by weight of oxytitanium phthalocyanine showing chief diffraction peaks at Bragg angles (2θ±0.2°) of 7.3°, 9.5°, 11.6°, 14.2°, 18.0°, 24.0° and 27.2° in a powder X-ray diffraction spectrum to CuKα characteristic X-ray (wavelength: 1.541 Å) as shown in FIG. 7.

### Comparative Preparation Example 1

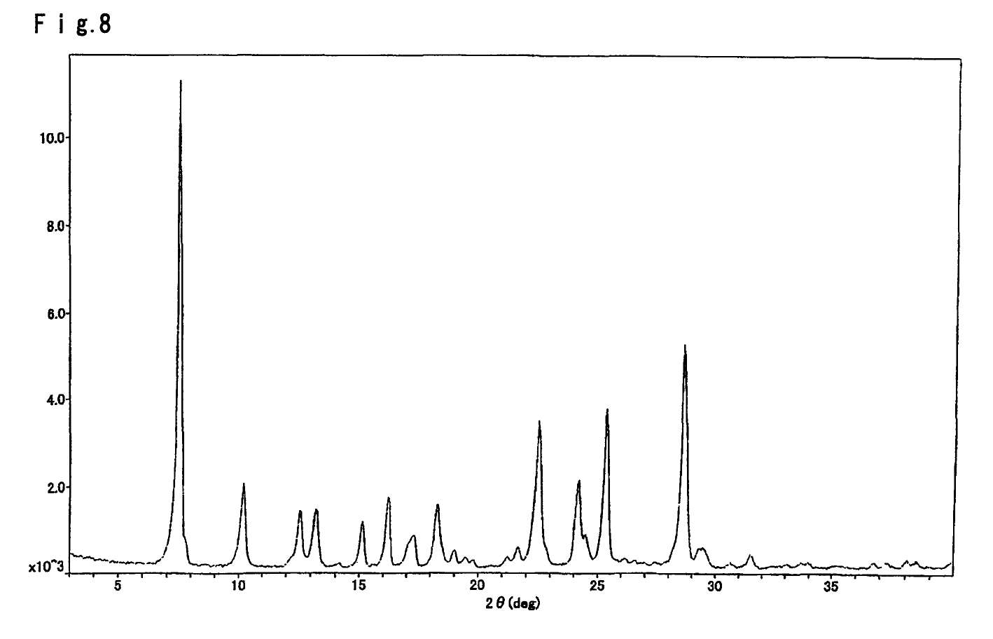

Oxytitanium phthalocyanine before crystal conversion was prepared in accordance with Example 1 as disclosed in JP-A-2-308863. The powder X-ray diffraction spectrum of the obtained oxytitanium phthalocyanine before crystal conversion is shown in FIG. 8. The chlorine content contained in the oxytitanium phthalocyanine crystals before crystal conversion was measured by the method as disclosed in the above “Measurement of chlorine content” and as a result, the chlorine content was 0.55 wt %. Further, the mass spectrum intensity ratio of chlorinated oxytitanium phthalocyanine to oxytitanium phthalocyanine was calculated in accordance with the above “Measurement of mass spectrum” and as a result, it was 0.058.

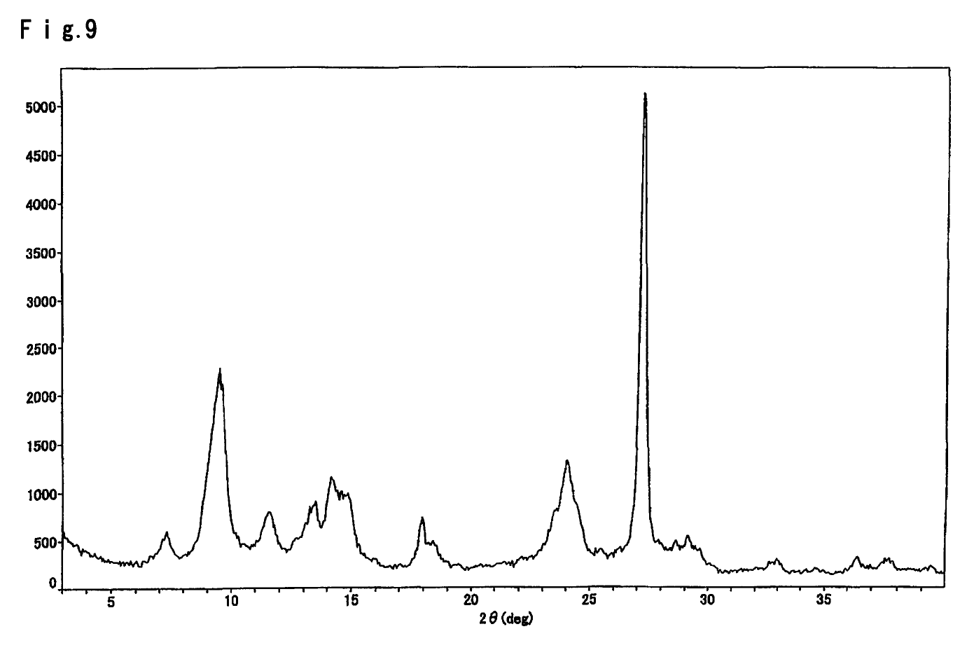

15 parts by weight of the obtained oxytitanium phthalocyanine and 170 parts by weight of glass beads of 1.0 to 1.4 mm in diameter were put in a polyethylene bottle, followed by treatment in a dye dispersion testing machine (paint shaker) for 20 hours (mechanical grinding treatment). The oxytitanium phthalocyanine after the grinding treatment was separated from the glass beads, and after separation, it was added in 250 parts by weight of water, followed by stirring at room temperature for 30 minutes. Then, 31 parts by weight of o-dichlorobenzene was added, followed by stirring at room temperature further for one hour. After stirring, water was separated, and 250 parts by weight of methanol was added, followed by stirring and washing at room temperature for one hour. After washing, filtration was carried out, stirring and washing were carried out again using 250 parts by weight of methanol for one hour, and then filtration was carried out, and drying by heating by a vacuum drier was carried out to obtain 14.3 parts by weight of oxytitanium phthalocyanine showing chief diffraction peaks at Bragg angles (2θ±0.2°) of 7.3°, 9.5°, 11.6°, 14.2°, 18.0°, 24.3° and 27.2° in a powder X-ray diffraction spectrum to CuKα characteristic X-ray (wavelength: 1.541 Å) as shown in FIG. 9.

### (Photoreceptor Production Method)

As a charge generation substance, 20 parts by weight of oxytitanium phthalocyanine and 280 parts by weight of 1,2-dimethoxyethane were mixed, followed by grinding by a sand grinding mill for 2 hours to conduct atomization dispersion treatment. Then, with the atomized treated liquid, a binder liquid obtained by dissolving 10 parts by weight of polyvinyl butyral (“Denka Butyral” #6000C, tradename, manufactured by Denki Kagaku Kogyo Kabushiki Kaisha) dissolved in a mixed liquid of 253 parts by weight of 1,2-dimethoxyethane and 85 parts by weight of 4-methoxy-4-methyl-2-pentanone, and 230 parts by weight of 1,2-dimethoxyethane were mixed to prepare a dispersion liquid. The dispersion liquid was applied by dip coating to an aluminum cylinder (diameter: 30 mm, length: 351 mm, thickness: 1 mm) subjected to anodic oxidation treatment to form a charge generation layer so that the thickness would be 0.3 μm (0.3 g/m²) after drying.

Then, 50 parts by weight of a charge transport substance, as a binder resin, 100 parts by weight of a polycarbonate resin comprising 51 mol wt % of repeating units comprising 2,2-bis(4-hydroxy-3-methylphenyl)propane represented by the following structural formula (A) as an aromatic diol component and 49 mol wt % of repeating units comprising 1,1-bis(4-hydroxyphenyl)-1-phenylethane represented by the following structural formula (B) as an aromatic diol component, and having a terminal structural formula derived from p-t-butylphenol, 8 parts by weight of 2,6-di-t-butyl-4-methylphenol and 0.03 part by weight of a silicone oil (KF96, tradename, manufactured by Shin-Etsu Chemical Co., Ltd.) as a leveling agent were dissolved in 640 parts by weight of a solvent mixture of tetrahydrofuran/toluene (weight ratio 8/2) to prepare a coating liquid for charge transport layer. Then, the coating liquid was applied by dip coating to the aluminum cylinder on which the charge generation layer was previously formed so that the thickness would be 18 μm after drying and dried to form a charge transport layer thereby to prepare an electrophotographic photoreceptor having a lamination type photosensitive layer:

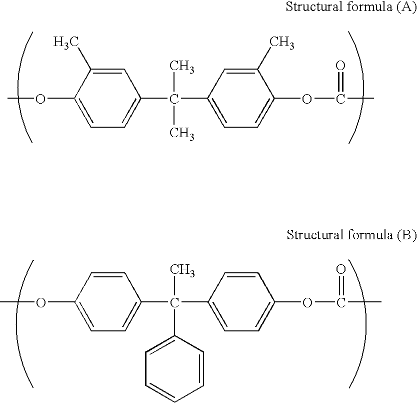

### Examples 1 to 12 and Comparative Examples 1 to 20

An electrophotographic photoreceptor having a lamination type photosensitive layer (function-separated photoreceptor) was prepared in accordance with the above electrophotographic photoreceptor preparation method using each of the oxytitanium phthalocyanines prepared in Preparation Examples 3 to 5 and Comparative Preparation Example 1 and each of charge transport substances represented by the following structural formulae (1) to (8). The combination of the oxytitanium phthalocyanine and the charge transport substance is shown in the following Table 1.

TABLE 1

| | |
|---|---|
| | Structural formula (1) |
| 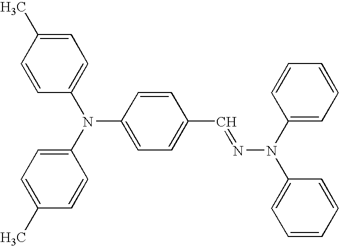 | |
| | Structural formula (2) |
| 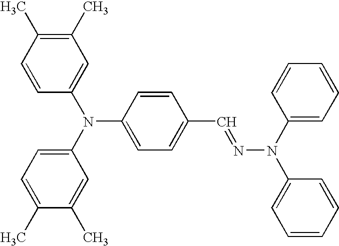 | |
| | Structural formula (3) |
| 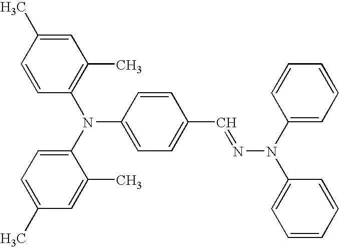 | |
| | Structural formula (4) |
| 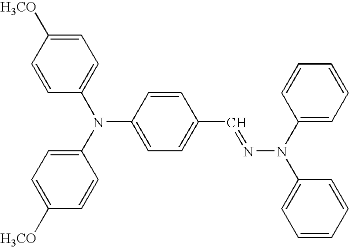 | |
| | Structural formula (5) |
| 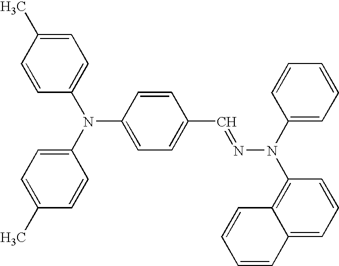 | |
| | Structural formula (6) |
| 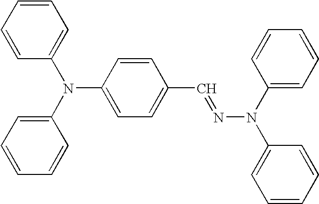 | |
| | Structural formula (7) |
| 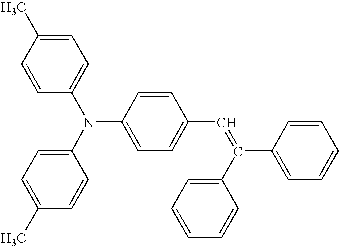 | |
| | Structural formula (8) |
| 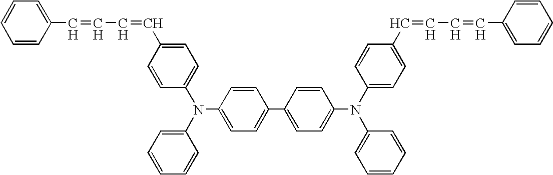 | |

| | Oxytitanium | Charge transport |
|---|---|---|
| | phthalocyanine | substance |
| Ex. 1 | Prep. Ex. 3 | Structural formula (1) |
| Ex. 2 | Prep. Ex. 4 | Structural formula (1) |
| Ex. 3 | Prep. Ex. 5 | Structural formula (1) |
| Ex. 4 | Prep. Ex. 3 | Structural formula (2) |
| Ex. S | Prep. Ex. 4 | Structural formula (2) |
| Ex. 6 | Prep. Ex. 5 | Structural formula (2) |
| Ex. 7 | Prep. Ex. 3 | Structural formula (3) |
| Ex. 8 | Prep. Ex. 4 | Structural formula (3) |
| Ex. 9 | Prep. Ex. 5 | Structural formula (3) |
| Ex. 10 | Prep. Ex. 3 | Structural formula (4) |
| Ex. 11 | Prep. Ex. 4 | Structural formula (4) |
| Ex. 12 | Prep. Ex. 5 | Structural formula (4) |
| Comp. Ex. 1 | Comp. Prep. Ex. 1 | Structural formula (1) |
| Comp. Ex. 2 | Comp. Prep. Ex. 1 | Structural formula (2) |
| Comp. Ex. 3 | Comp. Prep. Ex. 1 | Structural formula (3) |
| Comp. Ex. 4 | Comp. Prep. Ex. 1 | Structural formula (4) |
| Comp. Ex. 5 | Comp. Prep. Ex. 1 | Structural formula (5) |
| Comp. Ex. 6 | Comp. Prep. Ex. 1 | Structural formula (6) |
| Comp. Ex. 7 | Comp. Prep. Ex. 1 | Structural formula (7) |
| Comp. Ex. 8 | Comp. Prep. Ex. 1 | Structural formula (8) |
| Comp. Ex. 9 | Prep. Ex. 3 | Structural formula (5) |
| Comp. Ex. 10 | Prep. Ex. 4 | Structural formula (5) |
| Comp. Ex. 11 | Prep. Ex. 5 | Structural formula (5) |
| Comp. Ex. 12 | Prep. Ex. 3 | Structural formula (6) |
| Comp. Ex. 13 | Prep. Ex. 4 | Structural formula (6) |
| Comp. Ex. 14 | Prep. Ex. 5 | Structural formula (6) |
| Comp. Ex. 15 | Prep. Ex. 3 | Structural formula (7) |
| Comp. Ex. 16 | Prep. Ex. 4 | Structural formula (7) |
| Comp. Ex. 17 | Prep. Ex. 5 | Structural formula (7) |
| Comp. Ex. 18 | Prep. Ex. 3 | Structural formula (8) |
| Comp. Ex. 19 | Prep. Ex. 4 | Structural formula (8) |
| Comp. Ex. 20 | Prep. Ex. 5 | Structural formula (8) |

### (Test on Evaluation of Electric Characteristics)

Each of the electrophotographic photoreceptors obtained in Examples 1 to 12 and Comparative Examples 1 to 20 was attached to an electrophotographic characteristic evaluation apparatus (described in pages 404 to 405 in “Electrophotography Bases and applications, second series” edited by the Society of Electrophotography, published by Corona Co.) manufactured in accordance with the measurement standard by the Society of Electrophotography, electric characteristics were evaluated by cycles of charging, exposure, potential measurement and charge removal as follows.

The electrophotographic photoreceptor was charged so that the initial surface potential would be −700 V, and irradiated with a 780-nm monochromatic light converted from a light from a halogen lamp through an interference filter, and the irradiation energy (half decay exposure energy, unit: μJ/cm²) when the surface potential became −350 V was measured as the sensitivity (E1/2). Further, the surface potential after exposure (V1) 100 msec later when exposed at 1.2 μJ/cm² was measured. The results are shown in the following Table 2.

### (Image Evaluation Test)

Each of the electrophotographic photoreceptors obtained in Examples 1 to 12 and Comparative Examples 1 to 20 was attached to a cyan drum cartridge of a commercially available tandem color printer (Microline 3050c manufactured by Oki Data Corporation) corresponding to A3 printing, and the cartridge was attached to the above printer.

As the printing input, a pattern with bold characters on blank at the upper portion of an A3 region and a halftone portion from the center portion to the lower portion was fed from a personal computer to the printer, and the obtained output image was visually evaluated.

With the printer tested, which employs no photo-charge removal process, the character pattern at the upper portion is stored as the memory in the photoreceptor, which influences the image formation in the next rotation, i.e. the pattern appears as the memory image at the halftone portion in some cases depending upon the performance of the photoreceptor. The degree to such an extent the memory image appears on a portion which should be completely uniform, was visually evaluated on five scales of rank 1: memory image least observed to rank 5: memory image most clearly observed.

Further, this test was carried out in both normal environment (25° C./50% RH) and low temperature low humidity environment (5° C./10% RH). The results are shown in the following Table 3.

TABLE 2

| | | | | | Charge | | |
|---|---|---|---|---|---|---|---|
| | | Treatment | Cl content | | transport | E½ | |
| | TiOPc | method | (wt %) | Cl—TiOPc | material | (μJ/cm²) | VI (−V) |
| Ex. 1 | Prep. Ex. 3 | Acid paste | At most | 0.002 | Structural | 0.076 | 48 |
| | | | 0.20 | | formula (1) | | |
| Ex. 2 | Prep. Ex. 4 | Acid paste | At most | 0.002 | Structural | 0.078 | 34 |
| | | | 0.20 | | formula (1) | | |
| Ex. 3 | Prep. Ex. 5 | Acid paste | 0.51 | 0.055 | Structural | 0.081 | 39 |
| | | | | | formula (1) | | |
| Ex. 4 | Prep. Ex. 3 | Acid paste | At most | 0.002 | Structural | 0.076 | 46 |
| | | | 0.20 | | formula (2) | | |
| Ex. 5 | Prep. Ex. 4 | Acid paste | At most | 0.002 | Structural | 0.077 | 37 |
| | | | 0.20 | | formula (2) | | |
| Ex. 6 | Prep. Ex. 5 | Acid paste | 0.51 | 0.055 | Structural | 0.081 | 40 |
| | | | | | formula (2) | | |
| Ex. 7 | Prep. Ex. 3 | Acid paste | At most | 0.002 | Structural | 0.078 | 52 |
| | | | 0.20 | | formula (3) | | |
| Ex. 8 | Prep. Ex. 4 | Acid paste | At most | 0.002 | Structural | 0.079 | 46 |
| | | | 0.20 | | formula (3) | | |
| Ex. 9 | Prep. Ex. 5 | Acid paste | 0.51 | 0.055 | Structural | 0.081 | 48 |
| | | | | | formula (3) | | |
| Ex. 10 | Prep. Ex. 3 | Acid paste | At most | 0.002 | Structural | 0.074 | 39 |
| | | | 0.20 | | formula (4) | | |
| Ex. 11 | Prep. Ex. 4 | Acid paste | At most | 0.002 | Structural | 0.075 | 31 |
| | | | 0.20 | | formula (4) | | |
| Ex. 12 | Prep. Ex. 5 | Acid paste | 0.51 | 0.055 | Structural | 0.078 | 33 |
| | | | | | formula (4) | | |
| Comp. | Comp. Prep. | Dry | 0.55 | 0.058 | Structural | 0.077 | 31 |
| Ex. 1 | Ex. 1 | grinding | | | formula (1) | | |
| Comp. | Comp. Prep. | Dry | 0.55 | 0.058 | Structural | 0.078 | 33 |
| Ex. 2 | Ex. 1 | grinding | | | formula (2) | | |
| Comp. | Comp. Prep. | Dry | 0.55 | 0.058 | Structural | 0.08 | 43 |
| Ex. 3 | Ex. 1 | grinding | | | formula (3) | | |
| Comp. | Comp. Prep. | Dry | 0.55 | 0.058 | Structural | 0.076 | 25 |
| Ex. 4 | Ex. 1 | grinding | | | formula (4) | | |
| Comp. | Comp. Prep. | Dry | 0.55 | 0.058 | Structural | 0.079 | 65 |
| Ex. 5 | Ex. 1 | grinding | | | formula (5) | | |
| Comp. | Comp. Prep. | Dry | 0.55 | 0.058 | Structural | 0.08 | 68 |
| Ex. 6 | Ex. 1 | grinding | | | formula (6) | | |
| Comp. | Comp. Prep. | Dry | 0.55 | 0.058 | Structural | 0.081 | 54 |
| Ex. 7 | Ex. 1 | grinding | | | formula (7) | | |
| Comp. | Comp. Prep. | Dry | 0.55 | 0.058 | Structural | 0.082 | 30 |
| Ex. 8 | Ex. 1 | grinding | | | formula (8) | | |
| Comp. | Prep. Ex. 3 | Acid paste | At most | 0.002 | Structural | 0.076 | 70 |
| Ex. 9 | | | 0.20 | | formula (5) | | |
| Comp. | Prep. Ex. 4 | Acid paste | At most | 0.002 | Structural | 0.078 | 73 |
| Ex. 10 | | | 0.20 | | formula (5) | | |
| Comp. | Prep. Ex. 5 | Acid paste | 0.51 | 0.055 | Structural | 0.08 | 77 |
| Ex. 11 | | | | | formula (5) | | |
| Comp. | Prep. Ex. 3 | Acid paste | At most | 0.002 | Structural | 0.078 | 85 |
| Ex. 12 | | | 0.20 | | formula (6) | | |
| Comp. | Prep. Ex. 4 | Acid paste | At most | 0.002 | Structural | 0.081 | 78 |
| Ex. 13 | | | 0.20 | | formula (6) | | |
| Comp. | Prep. Ex. 5 | Acid paste | 0.51 | 0.055 | Structural | 0.086 | 91 |
| Ex. 14 | | | | | formula (6) | | |
| Comp. | Prep. Ex. 3 | Acid paste | At most | 0.002 | Structural | 0.079 | 69 |
| Ex. 15 | | | 0.20 | | formula (7) | | |
| Comp. | Prep. Ex. 4 | Acid paste | At most | 0.002 | Structural | 0.081 | 58 |
| Ex. 16 | | | 0.20 | | formula (7) | | |
| Comp. | Prep. Ex. 5 | Acid paste | 0.51 | 0.055 | Structural | 0.084 | 63 |
| Ex. 17 | | | | | formula (7) | | |
| Comp. | Prep. Ex. 3 | Acid paste | At most | 0.002 | Structural | 0.08 | 46 |
| Ex. 18 | | | 0.20 | | formula (8) | | |
| Comp. | Prep. Ex. 4 | Acid paste | At most | 0.002 | Structural | 0.083 | 34 |
| Ex. 19 | | | 0.20 | | formula (8) | | |
| Comp. | Prep. Ex. 5 | Acid paste | 0.51 | 0.055 | Structural | 0.085 | 38 |
| Ex. 20 | | | | | formula (8) | | |

TABLE 3

| | | | | | | | Low temp. |
|---|---|---|---|---|---|---|---|
| | | | | | Charge | | low |
| | | Treatment | Cl content | | transport | Normal | humidity |
| | TiOPc | method | (wt %) | Cl—TiOPc | material | memory | memory |
| Ex. 1 | Prep. Ex. 3 | Acid paste | At most | 0.002 | Structural | 1 | 1 |
| | | | 0.20 | | formula (1) | | |
| Ex. 2 | Prep. Ex. 4 | Acid paste | At most | 0.002 | Structural | 2 | 1 |
| | | | 0.20 | | formula (1) | | |
| Ex. 3 | Prep. Ex. 5 | Acid paste | 0.51 | 0.055 | Structural | 2 | 3 |
| | | | | | formula (1) | | |
| Ex. 4 | Prep. Ex. 3 | Acid paste | At most | 0.002 | Structural | 1 | 1 |
| | | | 0.20 | | formula (2) | | |
| Ex. 5 | Prep. Ex. 4 | Acid paste | At most | 0.002 | Structural | 1 | 2 |
| | | | 0.20 | | formula (2) | | |
| Ex. 6 | Prep. Ex. 5 | Acid paste | 0.51 | 0.055 | Structural | 2 | 3 |
| | | | | | formula (2) | | |
| Ex. 7 | Prep. Ex. 3 | Acid paste | At most | 0.002 | Structural | 1 | 1 |
| | | | 0.20 | | formula (3) | | |
| Ex. 8 | Prep. Ex. 4 | Acid paste | At most | 0.002 | Structural | 1 | 2 |
| | | | 0.20 | | formula (3) | | |
| Ex. 9 | Prep. Ex. 5 | Acid paste | 0.51 | 0.055 | Structural | 2 | 3 |
| | | | | | formula (3) | | |
| Ex. 10 | Prep. Ex. 3 | Acid paste | At most | 0.002 | Structural | 1 | 2 |
| | | | 0.20 | | formula (4) | | |
| Ex. 11 | Prep. Ex. 4 | Acid paste | At most | 0.002 | Structural | 2 | 2 |
| | | | 0.20 | | formula (4) | | |
| Ex. 12 | Prep. Ex. 5 | Acid paste | 0.51 | 0.055 | Structural | 2 | 3 |
| | | | | | formula (4) | | |
| Comp. | Comp. Prep. | Dry | 0.55 | 0.058 | Structural | 3 | 4 |
| Ex. 1 | Ex. 1 | grinding | | | formula (1) | | |
| Comp. | Comp. Prep. | Dry | 0.55 | 0.058 | Structural | 3 | 4 |
| Ex. 2 | Ex. 1 | grinding | | | formula (2) | | |
| Comp. | Comp. Prep. | Dry | 0.55 | 0.058 | Structural | 3 | 5 |
| Ex. 3 | Ex. 1 | grinding | | | formula (3) | | |
| Comp. | Comp. Prep. | Dry | 0.55 | 0.058 | Structural | 4 | 5 |
| Ex. 4 | Ex. 1 | grinding | | | formula (4) | | |
| Comp. | Comp. Prep. | Dry | 0.55 | 0.058 | Structural | 4 | 5 |
| Ex. 5 | Ex. 1 | grinding | | | formula (5) | | |
| Comp. | Comp. Prep. | Dry | 0.55 | 0.058 | Structural | 4 | 5 |
| Ex. 6 | Ex. 1 | grinding | | | formula (6) | | |
| Comp. | Comp. Prep. | Dry | 0.55 | 0.058 | Structural | 4 | 5 |
| Ex. 7 | Ex. 1 | grinding | | | formula (7) | | |
| Comp. | Comp. Prep. | Dry | 0.55 | 0.058 | Structural | 5 | 5 |
| Ex. 8 | Ex. 1 | grinding | | | formula (8) | | |
| Comp. | Prep. Ex. 3 | Acid paste | At most | 0.002 | Structural | 3 | 4 |
| Ex. 9 | | | 0.20 | | formula (5) | | |
| Comp. | Prep. Ex. 4 | Acid paste | At most | 0.002 | Structural | 3 | 4 |
| Ex. 10 | | | 0.20 | | formula (5) | | |
| Comp. | Prep. Ex. 5 | Acid paste | 0.51 | 0.055 | Structural | 4 | 5 |
| Ex. 11 | | | | | formula (5) | | |
| Comp. | Prep. Ex. 3 | Acid paste | At most | 0.002 | Structural | 3 | 4 |
| Ex. 12 | | | 0.20 | | formula (6) | | |
| Comp. | Prep. Ex. 4 | Acid paste | At most | 0.002 | Structural | 3 | 5 |
| Ex. 13 | | | 0.20 | | formula (6) | | |
| Comp. | Prep. Ex. 5 | Acid paste | 0.51 | 0.055 | Structural | 4 | 5 |
| Ex. 14 | | | | | formula (6) | | |
| Comp. | Prep. Ex. 3 | Acid paste | At most | 0.002 | Structural | 3 | 4 |
| Ex. 15 | | | 0.20 | | formula (7) | | |
| Comp. | Prep. Ex. 4 | Acid paste | At most | 0.002 | Structural | 3 | 4 |
| Ex. 16 | | | 0.20 | | formula (7) | | |
| Comp. | Prep. Ex. 5 | Acid paste | 0.51 | 0.055 | Structural | 4 | 4 |
| Ex. 17 | | | | | formula (7) | | |
| Comp. | Prep. Ex. 3 | Acid paste | At most | 0.002 | Structural | 4 | 4 |
| Ex. 18 | | | 0.20 | | formula (8) | | |
| Comp. | Prep. Ex. 4 | Acid paste | At most | 0.002 | Structural | 4 | 4 |
| Ex. 19 | | | 0.20 | | formula (8) | | |
| Comp. | Prep. Ex. 5 | Acid paste | 0.51 | 0.055 | Structural | 5 | 4 |
| Ex. 20 | | | | | formula (8) | | |

It is found from the above results that a photoreceptor with which a memory phenomenon hardly occurs regardless of environment can be obtained only when oxytitanium phthalocyanine obtained by chemical treatment method is used as the charge generation substance and a specific hydrazone compound is used as the charge transport substance. Further, it is found that a photoreceptor with which a memory phenomenon hardly occurs regardless of environment can be obtained also when oxytitanium phthalocyanine derived from a material having a low chlorine content is used as the charge generation substance and a specific hydrazone compound is used as the charge transport substance.

### INDUSTRIAL APPLICABILITY

According to the present invention, an electrophotographic photoreceptor capable of forming a high quality image free from image defects such as a memory phenomenon can be obtained by combining oxytitanium phthalocyanine containing a chlorinated product in a specific amount obtained by a specific process for producing a charge generation substance and a hydrazone compound having a specific structure as the charge transport substance. Such an electrophotographic photoreceptor is useful for an image forming apparatus and an electrophotographic cartridge.

The entire disclosure of Japanese Patent Application No. 2005-311775 filed on Oct. 26, 2005 including specification, claims, drawings and summary is incorporated herein by reference in its entirety.

1. An electrophotographic photoreceptor comprising an electroconductive substrate and a photosensitive layer formed thereon, characterized in that the photosensitive layer contains oxytitanium phthalocyanine showing chief diffraction peaks at Bragg angles (2θ±0.2°) of 9.6°, 24.1° and 27.2° to CuKα characteristic X-ray (wavelength: 1.541 Å) obtained by subjecting a phthalocyanine crystal precursor to chemical treatment and then bringing it into contact with an organic solvent, and a hydrazone compound represented by the following formula (1): 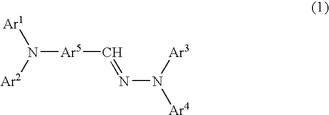
wherein each or Ar¹ and Ar² is an aryl group, provided that at least one of Ar¹ and Ar² is an aryl group having a substituent, each of Ar³ and Ar⁴ is a phenyl group which may have a substituent, and Ar⁵ is an arylene group which may have a substituent.

2. An electrophotographic photoreceptor comprising an electroconductive substrate and a photosensitive layer formed thereon, characterized in that the photosensitive layer contains oxytitanium phthalocyanine showing chief diffraction peaks at Bragg angles (2θ±0.2°) of 9.5°, 9.7°, 24.2° and 27.2° to CuKα characteristic X-ray (wavelength: 1.541 Å) obtained by subjecting a phthalocyanine crystal precursor to chemical treatment and then bringing it into contact with an organic solvent, and a hydrazone compound represented by the following formula (1): 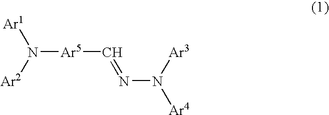
wherein each or Ar¹ and Ar² is an aryl group, provided that at least one of Ar¹ and Ar² is an aryl group having a substituent, each of Ar³ and Ar⁴ is a phenyl group which may have a substituent, and Ar⁵ is an arylene group which may have a substituent.

3. An electrophotographic photoreceptor comprising an electroconductive substrate and a photosensitive layer formed thereon, characterized in that the photosensitive layer contains oxytitanium phthalocyanine showing a chief diffraction peak at a Bragg angle (2θ±0.2°) of 27.2° to CuKα characteristic X-ray (wavelength: 1.541 Å) obtained by crystal conversion from oxytitanium phthalocyanine having a chlorine content of at most 0.4 wt %, or oxytitanium phthalocyanine in which the ratio of chlorinated oxytitanium phthalocyanine to non-substituted oxytitanium phthalocyanine is at most 0.05 by the mass spectrum intensity ratio, and a hydrazone compound represented by the following formula (1): 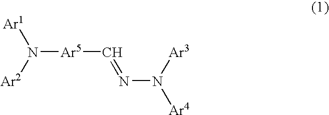
wherein each or Ar¹ and Ar² is an aryl group, provided that at least one of Ar¹ and Ar² is an aryl group having a substituent, each of Ar³ and Ar⁴ is a phenyl group which may have a substituent, and Ar⁵ is an arylene group which may have a substituent.

4. An electrophotographic process cartridge, comprising the electrophotographic photoreceptor as defined in any one of claims 1 to 3, constituted to be removable from an image forming apparatus.

5. An image forming apparatus, comprising the electrophotographic photoreceptor as defined in any one of claims 1 to 3, and at least one of a charging portion to charge the electrophotographic photoreceptor, an exposure portion to expose the charged electrophotographic photoreceptor to form an electrostatic latent image, and a developing portion to develop the electrostatic latent image formed on the electrophotographic photoreceptor.

6. The image forming apparatus according to claim 5, which comprises no charge removal process.
